(19) United States
(12) Patent Application Publication
(10) Pub. No.: US 2026/0292369 A1
(43) Pub. Date: Sep. 24, 2026

(54) APPARATUS, SYSTEM, AND MOVABLE BODY

(71) Applicant: CANON KABUSHIKI KAISHA, Tokyo (JP)

(72) Inventors: SHINTARO MAEKAWA, Kanagawa (JP); YASUHARU OTA, Tokyo (JP)

(21) Appl. No.: 19/551,156

(22) Filed: Feb. 26, 2026

(30) Foreign Application Priority Data
Mar. 21, 2025 (JP) 2025-046431

(51) Int. Cl. H04N 25/76; H04N 25/709; H04N 25/77

(52) U.S. Cl. CPC H04N 25/7795; H04N 25/709; H04N 25/77

(57) ABSTRACT

An apparatus includes a plurality of pixels each including an avalanche photodiode and a transistor, a first control circuit, a second control circuit, a first control line connected to the first control circuit and a first pixel group, and a second control line connected to the second control circuit and a second pixel group, wherein the first control circuit is disposed in a first region, the second control circuit is disposed in a second region, wherein the first and second regions are formed using divided exposure, wherein the first control line is connected to the first control circuit and the transistor included in the first pixel, wherein the second control line is connected to the second control circuit and the transistor included in the second pixel, and wherein the first and second control lines are electrically separated from each other.

### BACKGROUND

### Field of the Technology

The aspect of the embodiments relates to an apparatus, a system, and a movable body.

### Description of the Related Art

A photoelectric conversion apparatus capable of detecting weak light at a single-photon level using avalanche multiplication is known. Japanese Patent Laid-Open No. 2023-61644 describes a photoelectric conversion apparatus including an avalanche photodiode (APD) and a quench element connected between one of the nodes of the APD and a power supply.

However, there is room for improvement in the photoelectric conversion apparatus described in Japanese Patent Laid-Open No. 2023-61644.

In an exposure step as one of semiconductor manufacturing steps, in a case where a photoelectric conversion apparatus having a size exceeding the maximum exposure area of an exposure apparatus is manufactured, a divided exposure technique (a stitching exposure technique) for forming a pattern by dividing an exposure region and performing multiple exposures is used. When the divided exposure technique is used, the characteristic of a transistor to be formed or the wiring load differs with respect to each exposure region, whereby the delay amounts of control signals are different from each other. In a photoelectric conversion apparatus including an APD, if control lines that propagate control signals having different delay amounts are connected to each other, for example, the pulse widths of the control signals vary. Thus, for example, power consumption can increase, the detection accuracy of a photon can decrease, or data cannot be read in some pixels.

### SUMMARY

According to an aspect of the embodiments, an apparatus includes a plurality of pixels each including an avalanche photodiode and a transistor, a first control circuit and a second control circuit, a first control line connected to the first control circuit and a first pixel group including a plurality of pixels disposed next to each other in a first direction among the plurality of pixels, and a second control line connected to the second control circuit and a second pixel group including a plurality of pixels disposed next to each other in the first direction among the plurality of pixels, wherein the first control circuit is disposed in a first region, the second control circuit is disposed in a second region, and the first and second regions are formed using divided exposure, wherein a first pixel in the first pixel group and a second pixel in the second pixel group are disposed adjacent to each other in the first direction, wherein the first control line is connected to the first control circuit and the transistor included in the first pixel, wherein the second control line is connected to the second control circuit and the transistor included in the second pixel and having a same function as a function of the transistor included in the first pixel, and wherein the first and second control lines are electrically separated from each other.

According to another aspect of the embodiments, an apparatus includes a plurality of pixels each including an avalanche photodiode and a transistor, wherein the apparatus is in a shape of a rectangle, and a length of one side of the rectangle is longer than 33 millimeters (mm), or lengths of the one side and another side of the rectangle are both longer than 26 mm. The apparatus further includes a first control circuit disposed in a first region, a second control circuit disposed in a second region, a first control line connected to the first control circuit and a first pixel group including a plurality of pixels disposed next to each other in a first direction among the plurality of pixels, and a second control line connected to the second control circuit and a second pixel group including a plurality of pixels disposed next to each other in the first direction among the plurality of pixels, wherein a first pixel in the first pixel group and a second pixel in the second pixel group are disposed adjacent to each other in the first direction, wherein the first control line is connected to the first control circuit and the transistor included in the first pixel, wherein the second control line is connected to the second control circuit and the transistor included in the second pixel and having a same function as a function of the transistor included in the first pixel, and wherein the first and second control lines are electrically separated from each other.

Features of the disclosure will become apparent from the following description of embodiments with reference to the attached drawings. The following description of embodiments is described by way of example.

### BRIEF DESCRIPTION OF THE DRAWINGS

FIG. 1 is a schematic diagram of a photoelectric conversion apparatus according to an embodiment.

FIG. 2 illustrates an example of a configuration of a pixel of the photoelectric conversion apparatus according to an embodiment.

FIGS. 3A to 3C illustrate an example of driving of the pixel of the photoelectric conversion apparatus according to an embodiment.

FIG. 4 is a diagram illustrating a part of a configuration of a photoelectric conversion apparatus according to a first embodiment.

FIGS. 5A and 5B are schematic diagrams for describing the photoelectric conversion apparatus according to the first embodiment and a photoelectric conversion apparatus according to a comparative embodiment.

FIGS. 6A to 6D are diagrams for describing effects of the photoelectric conversion apparatus according to the first embodiment.

FIG. 7 is a diagram illustrating a part of a configuration of a photoelectric conversion apparatus according to a second embodiment.

FIG. 8 is a diagram illustrating a part of a configuration of a photoelectric conversion apparatus according to a third embodiment.

FIG. 9 is a schematic diagram of a photoelectric conversion apparatus according to a fourth embodiment.

FIG. 10 is a schematic diagram illustrating a sensor chip of the photoelectric conversion apparatus according to the fourth embodiment.

FIG. 11 is a schematic diagram illustrating a circuit chip of the photoelectric conversion apparatus according to the fourth embodiment.

FIG. 12 illustrates an example of a configuration of a pixel of the photoelectric conversion apparatus according to the fourth embodiment.

FIGS. 13A to 13C are diagrams illustrating an example of an operation of a pixel of a photoelectric conversion apparatus according to a fifth embodiment.

FIG. 14 is a diagram illustrating an example of a pixel of a photoelectric conversion apparatus according to a sixth embodiment.

FIGS. 15A to 15C are diagrams illustrating an example of an operation of a pixel of a photoelectric conversion apparatus according to the sixth embodiment.

FIG. 16 is a functional block diagram of a photoelectric conversion system according to a seventh embodiment.

FIGS. 17A and 17B are functional block diagrams of a photoelectric conversion system according to an eighth embodiment.

FIG. 18 is a functional block diagram of a photoelectric conversion system according to a ninth embodiment.

FIG. 19 is a functional block diagram of a photoelectric conversion system according to a tenth embodiment.

FIGS. 20A and 20B are functional block diagrams of a photoelectric conversion system according to an eleventh embodiment.

### DESCRIPTION OF THE EMBODIMENTS

The embodiments described below are provided to illustrate the technical concept of the disclosure and are not intended to limit the disclosure. The sizes and positional relationships of the components shown in the drawings may be exaggerated for clarity of explanation. In the following description, the same reference numerals are assigned to identical components, and repeated explanations thereof may be omitted.

Embodiments of the disclosure will be described in detail below based on the drawings. In the following description, terms indicating particular directions and positions (e.g., "up", "down", "right", and "left" and other terms including these terms) are used where necessary. These terms are used to facilitate the understanding of the embodiments with reference to the drawings, and the meanings of the terms do not limit the technical scope of the disclosure.

In the specification, a "planar view" refers to a view from a direction perpendicular to a light incident surface of a semiconductor layer. A "cross-sectional view" refers to a view of a surface in a direction perpendicular to the light incident surface. In a case where the light incident surface of the semiconductor layer is a rough surface when viewed microscopically, a planar view is defined based on the light incident surface of the semiconductor layer when viewed macroscopically.

In the following description, the anode of an avalanche photodiode (APD) is at a fixed potential, and a signal is extracted from the cathode side. Thus, a semiconductor region of a first conductivity type where charges having the same polarity as that of signal charges are majority carriers is an N-type semiconductor region, and a semiconductor region of a second conductivity type where charges having a polarity different from that of the signal charges are majority carriers is a P-type semiconductor region.

The disclosure holds true also in a case where the cathode of the APD is at a fixed potential, and a signal is extracted from the anode side. In this case, a semiconductor region of the first conductivity type where charges having the same polarity as that of signal charges are majority carriers is a P-type semiconductor region, and a semiconductor region of the second conductivity type where charges having a polarity different from that of the signal charges are majority carriers is an N-type semiconductor region. Although a description is given below of a case where one of the nodes of the APD is at a fixed potential, the potentials of both nodes may change.

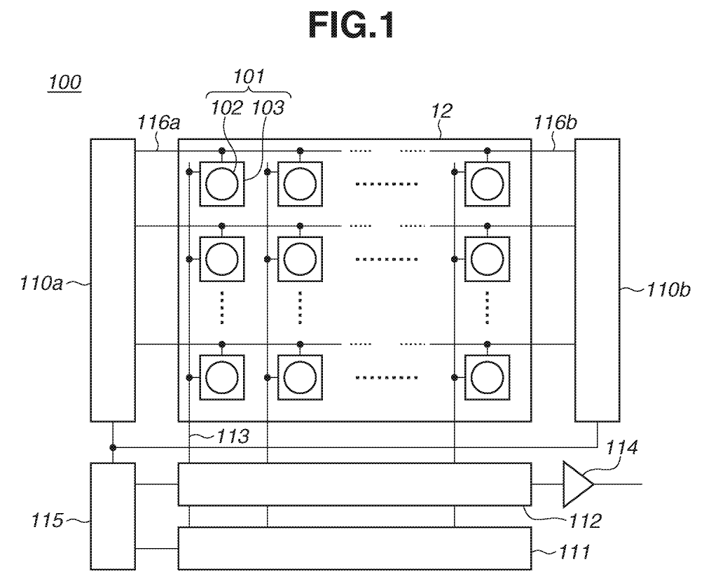

FIG. 1 is a diagram illustrating the configuration of a photoelectric conversion apparatus 100 according to an embodiment of the disclosure. The photoelectric conversion apparatus 100 includes a pixel region 12 where a plurality of pixels 101 is arranged in an array of a plurality of rows and a plurality of columns.

Each pixel 101 includes a photoelectric conversion unit 102 including an APD, and a signal processing circuit 103 that processes a charge photoelectrically converted by the photoelectric conversion unit 102. The pixel 101 is typically a pixel for forming an image. However, in a case where the pixel 101 is used for a distance measurement operation by a time-of-flight (ToF) method, the pixel 101 may not necessarily need to form an image. That is, the pixel 101 may also be a pixel for measuring the time when light reaches the pixel and the amount of the light.

The photoelectric conversion apparatus 100 further includes a reading circuit unit 112, a control pulse generation unit 115, a horizontal scanning circuit unit 111, output lines 113, a vertical scanning circuit unit 110a (a first control circuit), and a vertical scanning circuit unit 110b (a second control circuit). Although the vertical scanning circuit units 110a and 110b have similar configurations and functions, the positions where the vertical scanning circuit units 110a and 110b are placed in the photoelectric conversion apparatus 100 and pixels connected to the vertical scanning circuit units 110a and 110b are different from each other. In a case where common configurations and functions are described in the following description, signs "a" and "b" are omitted.

The vertical scanning circuit unit 110 receives a control pulse supplied from the control pulse generation unit 115 and supplies the control pulse to each pixel 101. As the vertical scanning circuit unit 110, a logic circuit such as a shift register, an address decoder, a gate circuit accompanying the shift register or the address decoder, or the like is used. The control pulse is supplied to each pixel 101 using a control line 116.

In a large-sized photoelectric conversion apparatus 100, there is a case where control pulses are supplied from a plurality of directions to the pixel region 12 to reduce the influence of the bluntness or the delay of a control pulse due to a large wiring load. For example, in FIG. 1, control pulses are supplied from two directions, namely left and right, to a plurality of pixels 101 arranged in a first direction. To a plurality of pixels 101 (a first pixel group) disposed on the left side in the pixel region 12, the vertical scanning circuit unit 110a supplies control pulses via a control line 116a (a first control line). To a plurality of pixels 101 (a second pixel group) disposed on the right side in the pixel region 12, the vertical scanning circuit unit 110b supplies control pulses via a control line 116b (a second control line).

A signal output from the photoelectric conversion unit 102 of each pixel 101 is processed by the signal processing circuit 103.

In the signal processing circuit 103, a counter circuit, a memory, and the like are provided. The memory holds a digital value.

To read signals from the memories of the pixels 101 holding digital signals, the horizontal scanning circuit unit 111 inputs control pulses for sequentially selecting columns to the signal processing circuits 103.

To the output lines 113, signals are output from signal processing circuits 103 corresponding to pixels 101 selected by the vertical scanning circuit unit 110 in a selected column.

The signals output to the output lines 113 are output to a recording unit or a signal processing unit outside the photoelectric conversion apparatus 100 via the reading circuit unit 112 and an output circuit 114. For example, the reading circuit unit 112 may have the function of rearranging data read from a plurality of output lines 113 in addition to the function of reading data via the output lines 113.

Although in FIG. 1, the plurality of pixels 101 in the pixel region 12 is disposed in a two-dimensional array, the disclosure is not limited to this. For example, the plurality of pixels 101 in the pixel region 12 may be arranged one-dimensionally. The functions of signal processing circuits 103 do not necessarily need to be provided one by one for all the pixels 101, and for example, a single signal processing circuit 103 may be shared by a plurality of pixels 101 and sequentially perform signal processing.

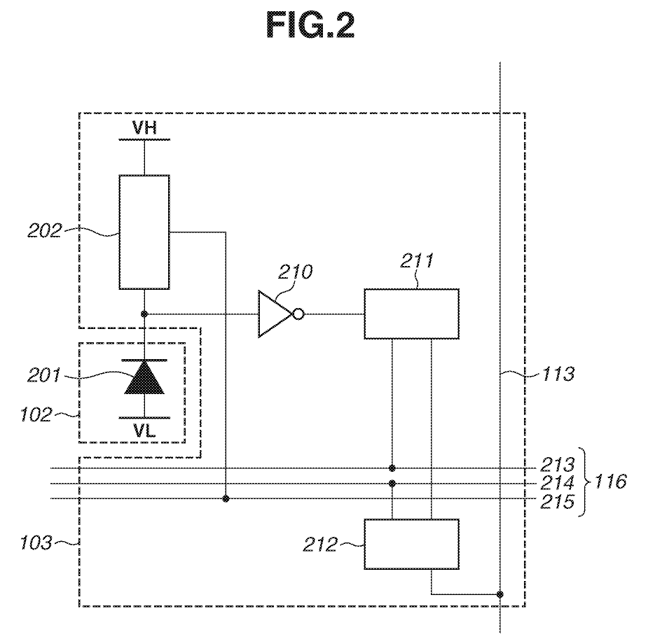

FIG. 2 illustrates an example of a block diagram including an equivalent circuit of each pixel 101 in FIG. 1. In FIG. 2, the photoelectric conversion unit 102 includes an APD 201, and the signal processing circuit 103 includes a quench element 202, a waveform shaping unit 210, a counter circuit 211, and a selection circuit 212. It is not essential that the signal processing circuit 103 includes all these components, and the signal processing circuit 103 may only need to include at least one of the quench element 202, the counter circuit 211, and the selection circuit 212.

The APD 201 generates a charge pair according to incident light through photoelectric conversion. To the anode of the APD 201, a voltage VL (a first voltage) is supplied. To the cathode of the APD 201, a voltage VH (a second voltage) higher than the voltage VL supplied to the anode is supplied. To the anode and the cathode of the APD 201, reverse bias voltages that cause the APD 201 to perform an avalanche multiplication operation are supplied. The APD 201 is brought into the state where such voltages are supplied, whereby the charges generated by the incident light cause avalanche multiplication, and an avalanche current is generated.

In a case where reverse bias voltages are supplied, there are a Geiger mode for causing the APD 201 to operate in the state where the potential difference between the anode and the cathode is greater than the breakdown voltage, and a linear mode for causing the APD 201 to operate in the state where the potential difference between the anode and the cathode is close to or less than or equal to the breakdown voltage. An APD caused to operate in the Geiger mode is referred to as a "single-photon avalanche diode (SPAD)". For example, the voltage VL is -30 V, and the voltage VH is 1 V.

The quench element 202 is connected to a power supply that supplies the voltage VH and one of the nodes of the APD 201. The quench element 202 is composed of a metal-oxide-semiconductor (MOS) transistor or a resistor element such as a poly resistor or the like. If a photocurrent is multiplied by avalanche multiplication in the APD 201, a current obtained by a multiplied charge flows through a connection node between the APD 201 and the quench element 202. Due to a voltage drop caused by this current, the potential of the cathode of the APD 201 decreases, and the APD 201 stops forming an electron avalanche. Consequently, the avalanche multiplication in the APD 201 stops. Then, the voltage VH is supplied to the cathode of the APD 201 via the quench element 202. Thus, the voltage supplied to the cathode of the APD 201 returns to the voltage VH.

That is, the operation region of the APD 201 returns to the operation in the Geiger mode again. As described above, the quench element 202 serves to function as a load circuit (a quench circuit) when a signal is multiplied by avalanche multiplication, and to reduce the voltage supplied to the APD 201, thereby preventing the avalanche multiplication (a quench operation). The quench element 202 also serves to return the operation region of the APD 201 to the Geiger mode again after preventing the avalanche multiplication.

The waveform shaping unit 210 shapes a change in the potential of the cathode of the APD 201 obtained when a photon is detected. Then, the waveform shaping unit 210 outputs a pulse signal. As the waveform shaping unit 210, for example, an inverter circuit is used. Although in FIG. 2, an example has been illustrated where a single inverter is used as the waveform shaping unit 210, a circuit where a plurality of inverters is connected in series may be used, or another circuit having a waveform shaping effect may be used.

The counter circuit 211 counts pulse signals output from the waveform shaping unit 210 and holds the count value. If a control pulse pRES is supplied to the counter circuit 211 via a control signal line 213, the counter circuit 211 may reset the signals held in the counter circuit 211, or may control a period when the counter circuit 211 receives an output from the waveform shaping unit 210. A plurality of control signal lines 213 may be provided.

To the selection circuit 212, a control pulse pSEL is supplied from the vertical scanning circuit unit 110 in FIG. 1 via a control signal line 214 in FIG. 2, and the selection circuit 212 selected by the control pulse pSEL outputs data held in the counter circuit 211 to the output line 113. For example, the selection circuit 212 can switch electrical connection and disconnection between the counter circuit 211 and the output line 113. For example, the selection circuit 212 may include a buffer circuit for outputting a signal, or the like. A plurality of control signal lines 214 may be provided.

To the quench element 202, a control pulse is supplied via a control signal line 215, and the quench element 202 can control the voltage supplied to the APD 201. A plurality of control signal lines 215 may be provided.

A switch such as a transistor or the like may be disposed between the quench element 202 and the APD 201 or between the photoelectric conversion unit 102 and the signal processing circuit 103, thereby switching electrical connection. Similarly, the supply of the voltage VL to the APD 201 may be electrically switched using a switch such as a transistor or the like. As illustrated in FIG. 2, each of the control signal line 213, the control signal line 214, and the control signal line 215 is one of the control lines 116 illustrated in FIG. 1.

In FIG. 2, a configuration has been illustrated in which the counter circuit 211 is used. Alternatively, the photoelectric conversion apparatus 100 may acquire the detection timing of a pulse using a time-to-digital conversion circuit (a time-to-digital converter: hereinafter, a "TDC") and a memory instead of the counter circuit 211. At this time, the generation timing of a pulse signal output from the waveform shaping unit 210 is converted into a digital signal by the TDC. To measure the timing of the pulse signal, a control pulse pREF (a reference signal) is supplied to the TDC from the vertical scanning circuit unit 110 in FIG. 1 via the control line 116. Using the control pulse pREF as a reference, the TDC acquires as a digital signal a signal when the input timing of a signal output from each pixel 101 via the waveform shaping unit 210 is a relative time.

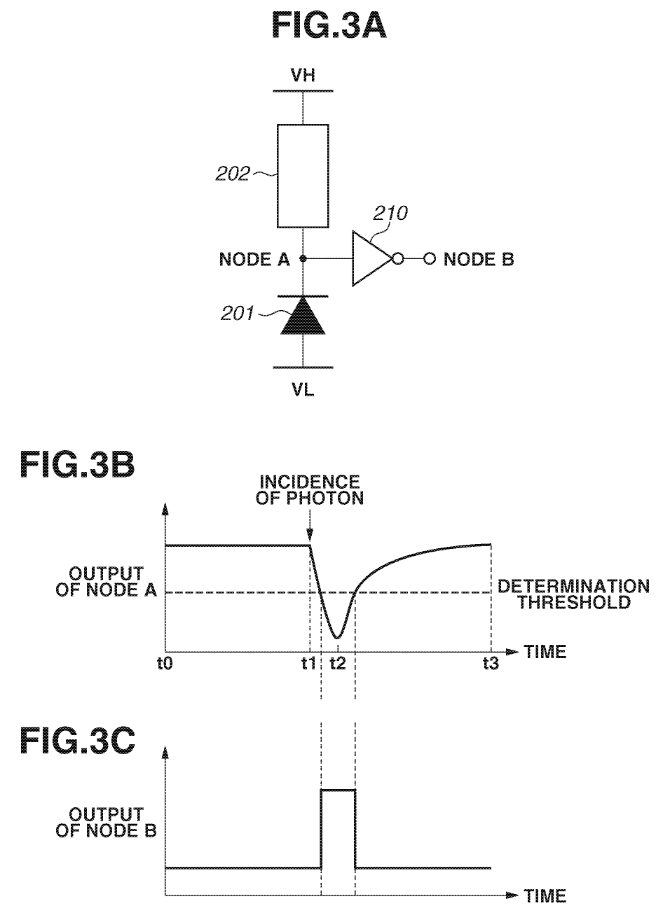

FIGS. 3A to 3C are diagrams schematically illustrating the relationship between the operation of the APD 201 and an output signal. FIG. 3A is a diagram illustrating excerpts of the APD 201, the quench element 202, and the waveform shaping unit 210 in FIG. 2. The input side of the waveform shaping unit 210 is a node A, and the output side of the waveform shaping unit 210 is a node B. FIG. 3B illustrates a change in the waveform of the node A in FIG. 3A. FIG. 3C illustrates a change in the waveform of the node B in FIG. 3A.

Between times t0 and t1, a potential difference of VH - VL is applied to the APD 201 in FIG. 3A.

At the time t1, if a photon is incident on the APD 201, an avalanche multiplication current flows through the quench element 202, and the voltage of the node A drops. If the amount of the voltage drop becomes greater and the potential difference applied to the APD 201 becomes smaller at a time t2, the avalanche multiplication in the APD 201 stops, and the voltage level of the node A does not drop any further beyond a certain value. Then, a current that compensates for the voltage drop flows through the node A from the voltage VH. At a time t3, the node A becomes static at the original potential level (a recharge operation).

At this time, the voltage level of the node A is input to the waveform shaping unit 210. If a portion of the output waveform of the node A exceeds a certain threshold, the waveform shaping unit 210 outputs a signal at a low level (hereinafter, "L level") to the node B. If a portion of the output waveform of the node A does not exceed the certain threshold, the waveform shaping unit 210 outputs a signal at a high level (hereinafter, "H level") to the node B. Consequently, the waveform is shaped. At this time, for example, the L level is a ground (GND) level of the waveform shaping unit 210, and the H level is a power supply voltage level of the waveform shaping unit 210.

### First Embodiment

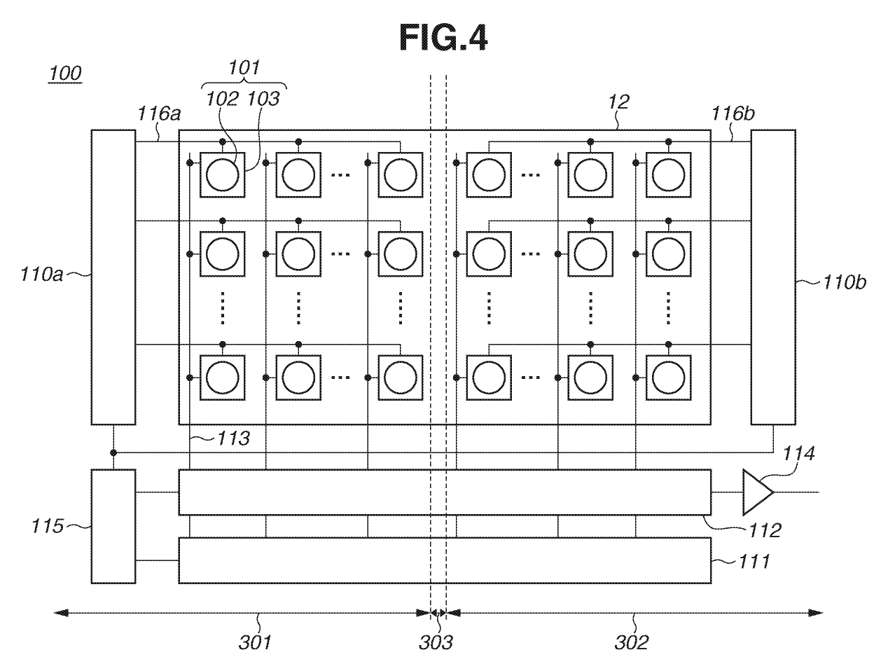

With reference to FIG. 4, a photoelectric conversion apparatus according to a first embodiment is described. There is a case where portions described with reference to FIGS. 1 to 3A to 3C are not described.

In the step of exposing a pattern for forming a transistor or wiring on a semiconductor wafer, the size of a region that can be exposed in a single exposure step is limited. Thus, when a large-sized photoelectric conversion apparatus 100 is manufactured, there is a case where all the regions of the photoelectric conversion apparatus 100 cannot be exposed in a single exposure. For example, the size of a region that can be collectively exposed by an exposure apparatus used to manufacture a semiconductor is 26 millimeters (mm) × 33 mm. In a case where the photoelectric conversion apparatus 100 is in the shape of a rectangle, and the length of one side (e.g., the long side) of the rectangle is longer than 33 mm, or the lengths of the one side and another side (e.g., the short side) of the rectangle are both longer than 26 mm, all the regions of the photoelectric conversion apparatus 100 cannot be collectively exposed.

In the specification, "rectangular" does not need to be strictly a rectangle, and also includes a rectangle with round corners or cut-off corners. In this case, there is a case where divided exposure (stitching exposure) in which all the regions of the photoelectric conversion apparatus 100 are exposed, for example, in two separate exposures is performed. For example, in the stitched exposure in which two exposures are performed, the photoelectric conversion apparatus 100 includes a first exposure region (a first region) where a pattern is formed by exposing the region using a first photomask, and a second exposure region (a second region) where a pattern is formed by exposing the region using a second photomask.

The photoelectric conversion apparatus 100 according to the embodiment is manufactured using stitched exposure. A target manufactured using the stitched exposure is at least one of a transistor and wiring, and not all the regions included in the photoelectric conversion apparatus 100 need to be formed by the stitched exposure. Although the stitched exposure in which two exposures are performed is described below, stitched exposure in which three or more exposures are performed may be employed.

In FIG. 4, a first region 301 is a region including components formed in the first exposure region in a planar view, and a second region 302 is a region including components formed in the second exposure region in the planar view.

A third region 303 is a region where the first and second exposure regions overlap each other and are doubly exposed. In this case, for example, pixels 101 and the vertical scanning circuit unit 110a in the first region 301 and pixels 101 and the vertical scanning circuit unit 110b in the second region 302 are exposed at different timings depending on the patterns of the masks that differ in elements such as transistors or the like or wiring. At this time, a characteristic difference can occur between the elements or the wiring formed in the first region 301 and the second region 302 due to a positional shift caused by an alignment error in the masks for the exposure and a semiconductor wafer, a manufacturing error in the pattern of each mask, or the like.

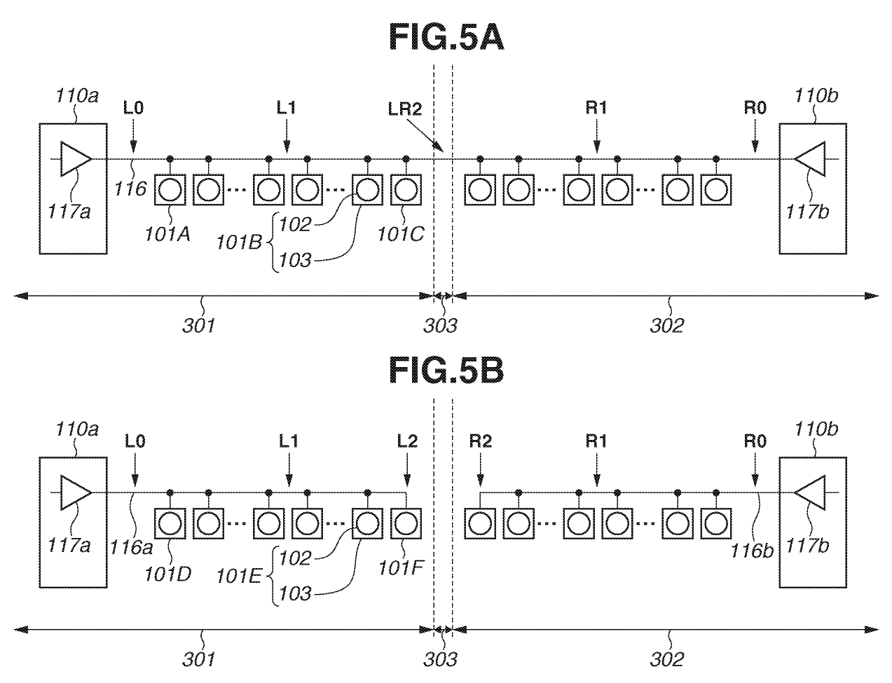

With reference to FIGS. 5A and 5B and6A to 6D, the effects of the embodiment are described by comparing the configurations and the operations of the embodiment and a comparative embodiment.

FIG. 5A is a diagram illustrating the configuration of the comparative embodiment. FIG. 5B is a diagram illustrating the configuration of the embodiment. In each of FIGS. 5A and 5B, a control pulse is supplied from a buffer circuit 117 of a vertical scanning circuit unit 110 to a pixel 101 via a control line 116.

In FIG. 5A illustrating the comparative embodiment, a control line 116 driven by the vertical scanning circuit unit 110a in the first region 301 and a control line 116 driven by the vertical scanning circuit unit 110b in the second region 302 are the same control line and electrically connected to each other. On the other hand, in FIG. 5B illustrating the embodiment, a control line 116a driven by the vertical scanning circuit unit 110a in the first region 301 and a control line 116b driven by the vertical scanning circuit unit 110b in the second region 302 are electrically separated from each other. In other words, the control lines 116a and 116b are not connected to each other.

First, the comparative embodiment is described.

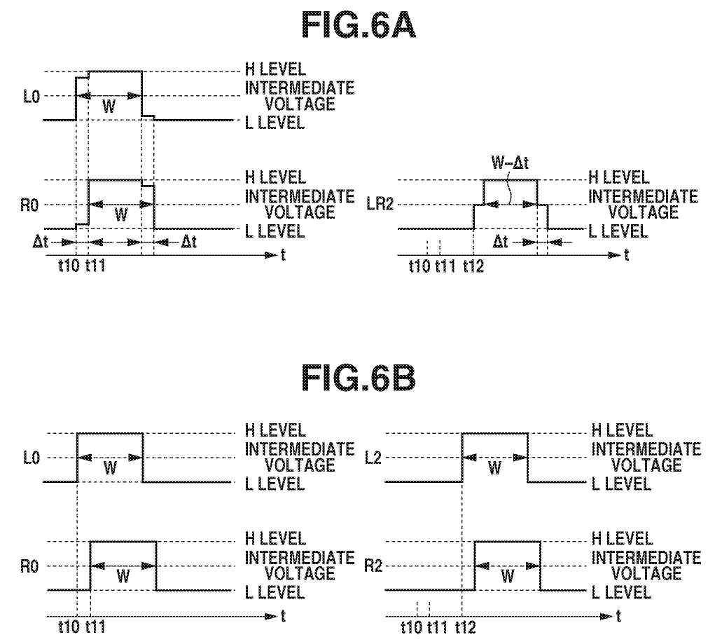

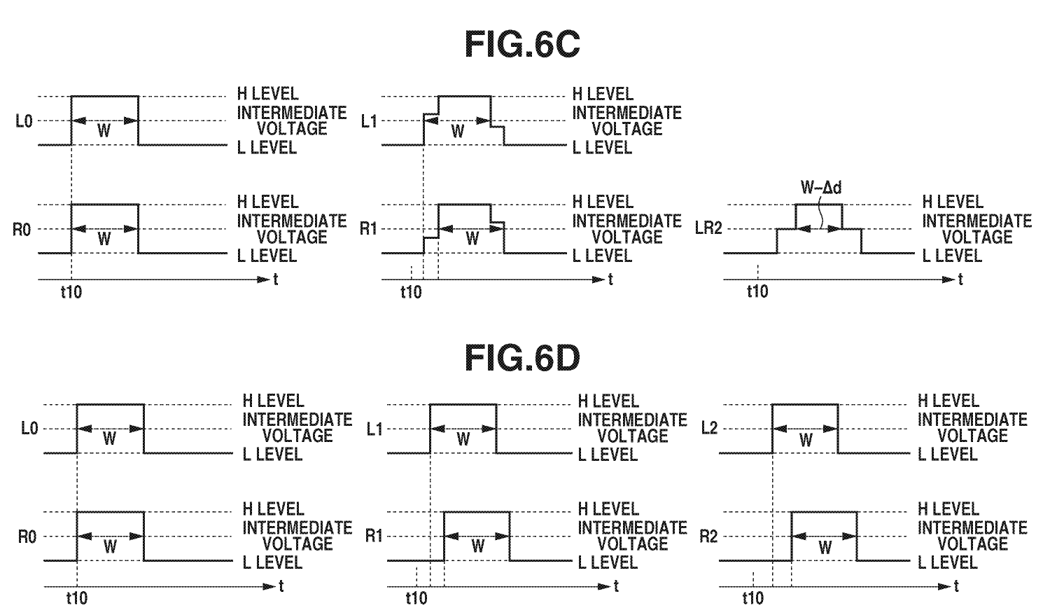

FIG. 6A illustrates examples of the states of control pulses at points L0, R0, and LR2 on the control line 116 in FIG. 5A. Control pulses generated by the vertical scanning circuit unit 110 are each intensified by the buffer circuit 117 connected in series to the control line 116, and output to the control line 116. At this time, a characteristic difference can occur between elements or wiring formed in the first region 301 and the second region 302 due to the stitched exposure. For example, a case is assumed where each of a buffer circuit 117a of the vertical scanning circuit unit 110a and a buffer circuit 117b of the vertical scanning circuit unit 110b is formed by the divided exposure. In this case, it is possible that the timings of control pulses input to the buffer circuits 117a and 117b or control pulses output from the buffer circuits 117a and 117b are shifted from each other.

For example, in FIG. 6A, with a time t10 as a starting point, the buffer circuit 117a operates to raise the control line 116 to an H level during a period having a pulse width W. On the other hand, with a time t11 after the lapse of Δt from the time t10 as a starting point, the buffer circuit 117b operates to raise the control line 116 to the H level during a period having the pulse width W. For example, an L level is a GND level of each buffer circuit 117, and the H level is a power supply voltage level of the buffer circuit 117.

At the time t10, the buffer circuit 117a operates to raise the control line 116 to the H level, but the buffer circuit 117b operates to continuously maintain the control line 116 at the L level. At this time, if the wiring resistance of the control line 116 is uniform and the output resistance of each buffer circuit 117 is smaller than the wiring resistance, then at the point L0 close to the buffer circuit 117a, the voltage is raised from the L level, and the potential of the point L0 is a voltage near the H level. Also, at the point R0 close to the buffer circuit 117b, the voltage is raised from the L level, but the potential of the point R0 is a voltage near the L level because the point R0 is close to the buffer circuit 117b.

At the time t11, the buffer circuits 117a and 117b both raise the control line 116 to the H level, and therefore, at both the points L0 and R0, the voltages are at the H level.

If the period W elapses from the time t10, the buffer circuit 117a operates to lower the control line 116 to the L level, but the buffer circuit 117b operates to continuously maintain the control line 116 at the H level. At this time, at the point L0 close to the buffer circuit 117a, the voltage is lowered from the H level, and the potential of the point L0 is a voltage near the L level. Also, at the point R0 close to the buffer circuit 117b, the voltage is lowered from the H level, but the potential of the point R0 is a voltage near the H level because the point R0 is close to the buffer circuit 117b.

If the period W elapses from the time t11, the buffer circuits 117a and 117b both lower the control line 116 to the L level, and therefore, at both the points L0 and R0, the voltages are at the L level.

At this time, if the period when a control pulse exceeds an intermediate voltage between the H level and the L level is defined as a pulse width, the pulse widths of pulses output from the buffer circuits 117a and 117b are W, and the pulse widths at the points L0 and R0 also remain W. The definition of the pulse width is merely an example, and the pulse width may be defined based on another voltage level.

At a time t12, a signal that is output from the buffer circuit 117a at the time t10 and raises the control line 116 to the H level, and a signal that is output from the buffer circuit 117b at the time t10 and maintains the control line 116 at the L level reach a point LR2, and therefore, the voltage of the point LR2 does not reach the H level. The distance between the point LR2 and the buffer circuit 117a and the distance between the point LR2 and the buffer circuit 117b are the same as each other, and therefore, the voltage of the point LR2 is the intermediate voltage between the H level and the L level. At this time, the pulse width is W - Δt, and the pulse widths of the pulses output from the buffer circuits 117a and 117b are different from W. Particularly, a pixel 101C disposed at a position distant from the buffer circuit 117a is likely to be influenced by the buffer circuit 117b. That is, the pulse widths of supplied control pulses vary between a pixel 101A disposed near the buffer circuit 117a and the pixel 101C disposed at a position distant from the buffer circuit 117a. There is a possibility that due to this variation in the pulse widths, the operations of the signal processing circuits 103 of the pixels 101A and 101C vary. At this time, if the pulse width of a pulse supplied from the control signal line 214 to the selection circuit 212 illustrated in FIG. 2 is short, the time required to read a signal from the pixel 101 is not secured. Thus, an issue can arise where in a pixel 101 to which a control signal having a short pulse width is supplied, the reading of a signal fails.

FIG. 6C illustrates a comparative embodiment different from that in FIG. 6A. FIG. 6C is a diagram illustrating a case where a control pulse is supplied from outside the photoelectric conversion apparatus 100 to each of the buffer circuits 117a and 117b or a case where a circuit for synchronizing control pulses between the first region 301 and the second region 302 is provided. FIG. 6C illustrates examples of the states of control pulses at points L0, L1, R0, R1, and LR2 on the control line 116 in FIG. 5A. Portions similar to those in FIG. 6A are not described.

Unlike FIG. 6A, at a time t10, pulses from the buffer circuits 117a and 117b simultaneously switch to the H level, and the H level is maintained during a period W. However, in a case where the driving forces of the buffer circuits 117a and 117b or the wiring loads of the control lines 116a and 116b are different from each other due to the characteristic difference between elements caused by the stitched exposure, it is possible that the delay amounts of the control pulses on the control lines 116a and 116b are different from each other. Specifically, this is a case where a transistor and wiring disposed in the first region 301 and a transistor and wiring disposed in the second region 302 are formed by the divided exposure. In this case, for example, there is a case where the driving force of the transistor disposed in the first region 301 is higher than the driving force of the transistor disposed in the second region 302 or a case where the load of the wiring disposed in the first region 301 is smaller than that of the wiring disposed in the second region 302. In this case, as illustrated in FIG. 6C, at the points L0 and R0, the rising timings of control pulses are the same as each other at the time t10, whereas at the points L1 and R1, a control pulse at the point R1 is more delayed.

This results in the same states as those of the points L0 and R0 illustrated in FIG. 6A. The point LR2 in FIG. 6C is also similar to that in FIG. 6A. For example, at the point LR2, if the absolute value of the difference between the delay amounts of two pulses is Δd, the pulse width is W - Δd and is a period different from the pulse widths W of the pulses output from the buffer circuits 117a and 117b. Consequently, the same issue as that in FIG. 6A can arise.

Next, the embodiment is described.

FIG. 6B illustrates examples of the states of control pulses at points L0, L1, and L2 on the control line 116a and points R0, R1, and R2 on the control line 116b in FIG. 5B.

FIG. 6B illustrates an embodiment corresponding to the comparative embodiment in FIG. 6A. Portions similar to those in FIG. 6A are not described.

In the embodiment, as described above, the control lines 116a and 116b are not connected to each other. Consequently, at a time t10, a signal at the H level is output from the buffer circuit 117a. At the point L0, the voltage is raised from the L level to the H level. Thus, there is not a period when the control pulse is between the H level and the L level as illustrated in FIG. 6A. Thus, the pulse widths at the points L0, R0, L2, and R2 do not greatly vary from W. That is, the pulse widths W of supplied control pulses do not vary between a pixel 101D near the buffer circuit 117a and a pixel 101F distant from the buffer circuit 117a. Thus, the period W when the selection circuit 212 is selected is constant at all the points, and the issue that can arise in the comparative embodiment in FIG. 6A does not arise.

As described above, there is a case where the timing when a control pulse is input to the buffer circuit 117a and the timing when a control pulse is input to the buffer circuit 117b are shifted from each other due to manufacturing variation in elements or wiring when the stitched exposure is performed. In the embodiment, the timings when control pulses are input may be further purposely shifted, for example, using a delay circuit. This is because also in this case, according to the embodiment, the control lines 116a and 116b are electrically separated from each other and therefore can make the pulse widths less likely to vary due to a shift between the timings. In a digital circuit, when the level shifts, much consumption current is generated. The timings are further purposely shifted, whereby the generation timing of consumption current generated in the first region 301 and the generation timing of consumption current generated in the second region 302 can be shifted from each other. This improves the stability of the power supply voltage.

FIG. 6D illustrates examples of the states of control pulses at points L0, L1, and L2 on the control line 116a and points R0, R1, and R2 on the control line 116b in FIG. 5B illustrating the embodiment. Portions similar to those in FIGS. 6B and 6C are not described. FIG. 6D illustrates an embodiment corresponding to the comparative embodiment in FIG. 6C. That is, FIG. 6D is a diagram illustrating a case where in the embodiment, a control pulse is supplied from outside the photoelectric conversion apparatus 100 to each of the buffer circuits 117a and 117b or a case where a circuit for synchronizing control pulses between the first region 301 and the second region 302 is provided. Portions similar to those in FIG. 6A are not described.

In the embodiment, the control line 116a to which a control pulse is transmitted from the vertical scanning circuit unit 110a in the first region 301 and the control line 116b to which a control pulse is transmitted from the vertical scanning circuit unit 110b in the second region 302 are not connected to each other. Thus, unlike the control pulse at the point LR2 in FIG. 6C, the pulse widths of pulses at the points L2 and R2 do not greatly vary from W.

That is, the issue that can arise in the comparative embodiment in FIG. 5A does not arise.

Although in FIG. 5B, the vertical scanning circuit unit 110a supplies control pulses to a pixel group including a plurality of pixels 101 in the first region 301, and the vertical scanning circuit unit 110b supplies control pulses to a pixel group including a plurality of pixels 101 in the second region 302, the disclosure is not limited to this. For example, the vertical scanning circuit unit 110a in the first region 301 may supply control pulses to some pixels 101 in the second region 302. The third region 303 may not necessarily need to be at an equal distance from the vertical scanning circuit unit 110a in the first region 301 and the vertical scanning circuit unit 110b in the second region 302. In one embodiment, the number of pixels 101 connected to the buffer circuit 117a via the control line 116a is the same as the number of pixels 101 connected to the buffer circuit 117b in the second region 302 via the control line 116b. Consequently, the wiring loads of the control lines 116a and 116b are equal to each other, and the delay amounts of control pulses are the same as each other. The number of pixels 101 connected to the buffer circuit 117a via the control line 116a and the number of pixels 101 connected to the buffer circuit 117b in the second region 302 via the control line 116b may be different from each other.

Although in the above description, an example has been described where the first region 301 includes the first pixel group, wiring forming the control line 116a, and the vertical scanning circuit unit 110a, and the second region 302 includes the second pixel group, wiring forming the control line 116b, and the vertical scanning circuit unit 110b, the disclosure is not limited to this. For example, the first region 301 may only need to include at least the vertical scanning circuit unit 110a, and the second region 302 may only need to include at least the vertical scanning circuit unit 110b. At this time, the pixel region 12 may be disposed in one of the first region 301 and the second region 302. Also in this case, it is possible to obtain the effects of, for example, stabilizing the reading time of data and reducing power consumption compared to the comparative embodiment.

According to the embodiment, it is possible to achieve a reduction in power consumption, an improvement in the detection accuracy of a photon, and the stabilization of the reading time of data.

### Second Embodiment

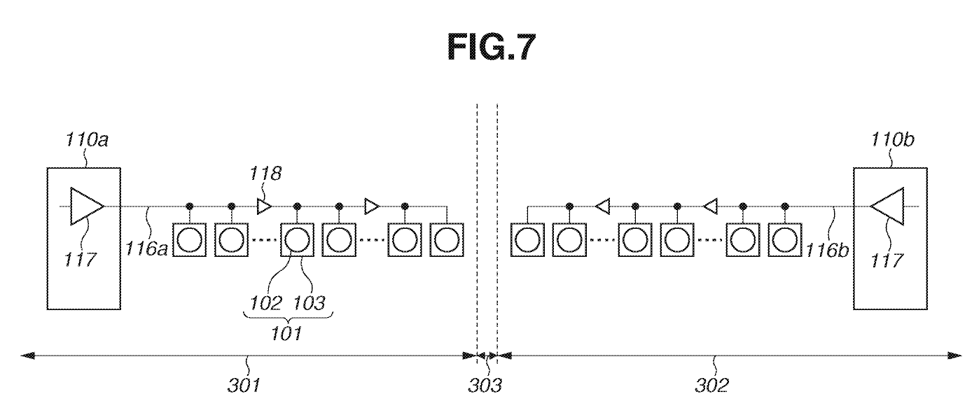

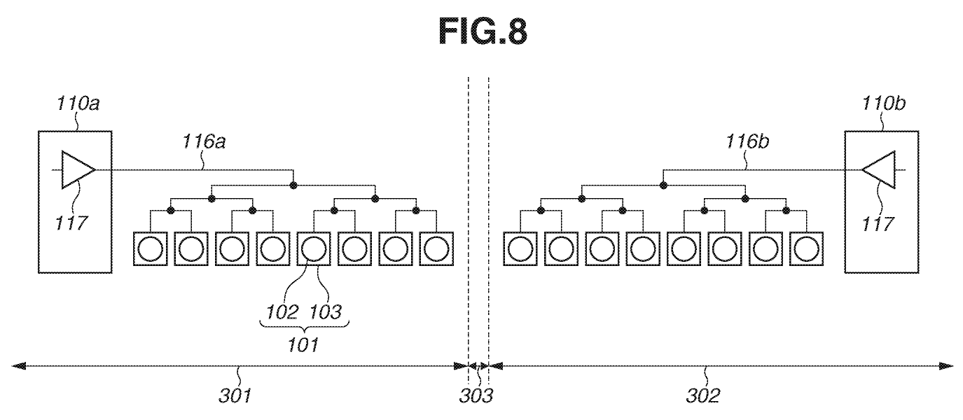

FIG. 7 illustrates a photoelectric conversion apparatus according to a second embodiment. The photoelectric conversion apparatus according to the embodiment is different from that according to the first embodiment in that the control lines 116a and 116b include an intermediate buffer circuit 118. The embodiment is substantially similar to the first embodiment except for this point and the points described below, and therefore, these points are not described.

The intermediate buffer circuit 118 is connected in series to the control lines 116a and 116b. Although only at least one intermediate buffer circuit 118 may be required, in one embodiment, a plurality of intermediate buffer circuits 118 are provided.

According to the embodiment, when a control pulse is supplied to a pixel 101 via a control line 116, the intermediate buffer circuit 118 is placed in the middle of the control line 116. Thus, it is possible to reduce delay caused by the bluntness of the control pulse due to a wiring load.

### Third Embodiment

FIG. 8 illustrates a photoelectric conversion apparatus according to a third embodiment. The photoelectric conversion apparatus according to the embodiment is different from that according to the first embodiment in that the control lines 116a and 116b are wiring using a clock tree method. The embodiment is substantially similar to the first embodiment except for this point and the points described below, and therefore, these points are not described.

According to the embodiment, each of the control lines 116a and 116b is wiring using the clock tree method, whereby it is possible to make the delay amounts of control pulses the same between the pixels 101. Although in FIG. 8, the intermediate buffer circuit 118 is not placed, the control lines 116a and 116b may include the intermediate buffer circuit 118 similarly to the second embodiment.

### Fourth Embodiment

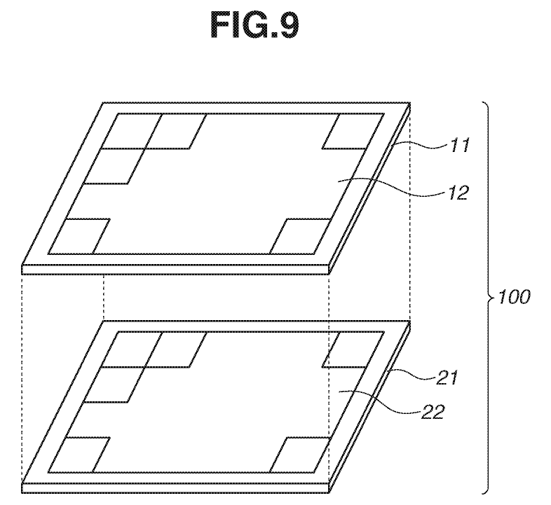

With reference to FIGS. 9 to 12, a photoelectric conversion apparatus according to a fourth embodiment is described. The photoelectric conversion apparatus according to the embodiment is different from that according to the first embodiment in that the photoelectric conversion apparatus according to the embodiment is a laminated photoelectric conversion apparatus configured by laminating and electrically connecting two chips, namely a sensor chip 11 (a first substrate) and a circuit chip 21 (a second substrate). The embodiment is substantially similar to the first embodiment except for this point and the points described below, and therefore, these points may not be described.

FIG. 9 is a diagram illustrating the configuration of the laminated photoelectric conversion apparatus according to the embodiment. In the photoelectric conversion apparatus 100, two chips, namely a sensor chip 11 and a circuit chip 21, are laminated together. In the sensor chip 11, a pixel region 12 is disposed. In the circuit chip 21, a circuit region 22 where a signal detected in the pixel region 12 is processed is disposed.

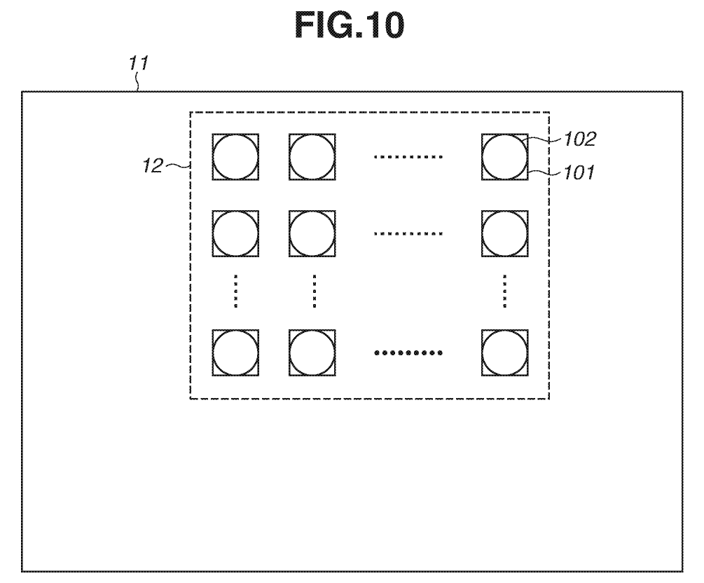

FIG. 10 is a diagram illustrating the placement of the sensor chip 11. The pixel region 12 is formed by arranging pixels 101 each including a photoelectric conversion unit 102 including an APD in an array of a plurality of rows and a plurality of columns.

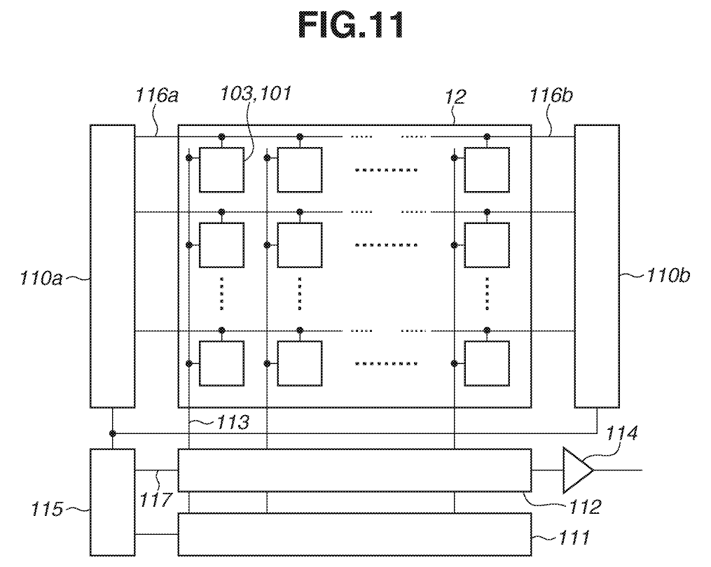

FIG. 11 is a diagram illustrating the configuration of the circuit chip 21. The circuit chip 21 includes signal processing circuits 103 that process charges photoelectrically converted by the photoelectric conversion units 102 in FIG. 10, a reading circuit unit 112, a control pulse generation unit 115, a horizontal scanning circuit unit 111, output lines 113, and vertical scanning circuit units 110a and 110b.

Each pixel 101 includes a photoelectric conversion unit 102 including an APD, and a signal processing circuit 103. The photoelectric conversion units 102 in FIG. 10 and the signal processing circuits 103 in FIG. 11 are electrically connected to each other via connection wiring provided on a pixel-by-pixel basis. The circuit region 22 is formed by arranging the signal processing circuits 103 in an array of a plurality of rows and a plurality of columns.

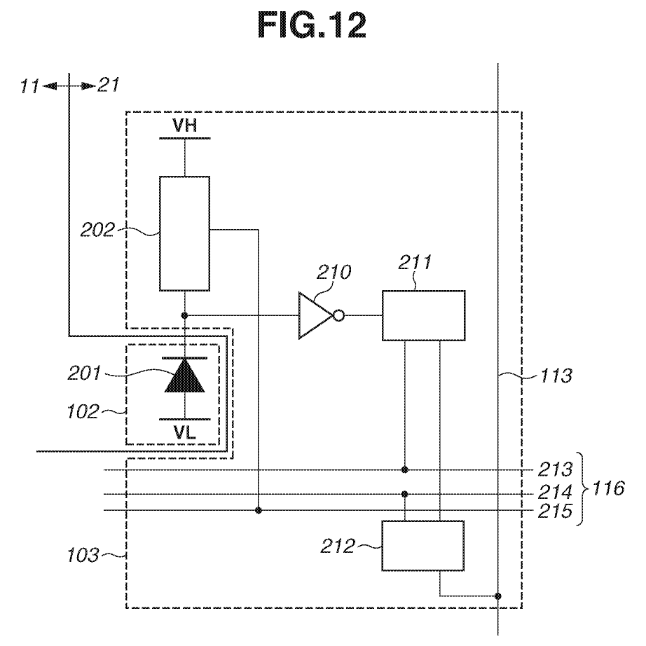

FIG. 12 illustrates an example of a block diagram including an equivalent circuit of FIGS. 10 and 11. In FIG. 9, the photoelectric conversion unit 102 including an APD 201 illustrated in FIG. 12 is provided in the sensor chip 11, and other members are provided in the circuit chip 21.

In the embodiment, in the circuit chip 21 illustrated in FIG. 11, the signal processing circuits 103, the reading circuit unit 112, the control pulse generation unit 115, the horizontal scanning circuit unit 111, the output lines 113, and the vertical scanning circuit units 110 are manufactured using the stitched exposure.

Although the stitched exposure may be performed in at least one of the sensor chip 11 and the circuit chip 21, in one embodiment, the circuit chip 21 is manufactured using the stitched exposure. This is because the circuit chip 21 is likely to require the accuracies of transistors and wiring. In this case, the sensor chip 11 may be manufactured using collective exposure. Also in the sensor chip 11, a pattern may be formed using the stitched exposure.

In the embodiment, the control lines 116a and 116b may include the intermediate buffer circuit 118 similarly to the second embodiment, or each of the control lines 116a and 116b may be wiring using the clock tree method similarly to the third embodiment.

Also in the embodiment, it is possible to obtain effects similar to those of the first embodiment.

### Fifth Embodiment

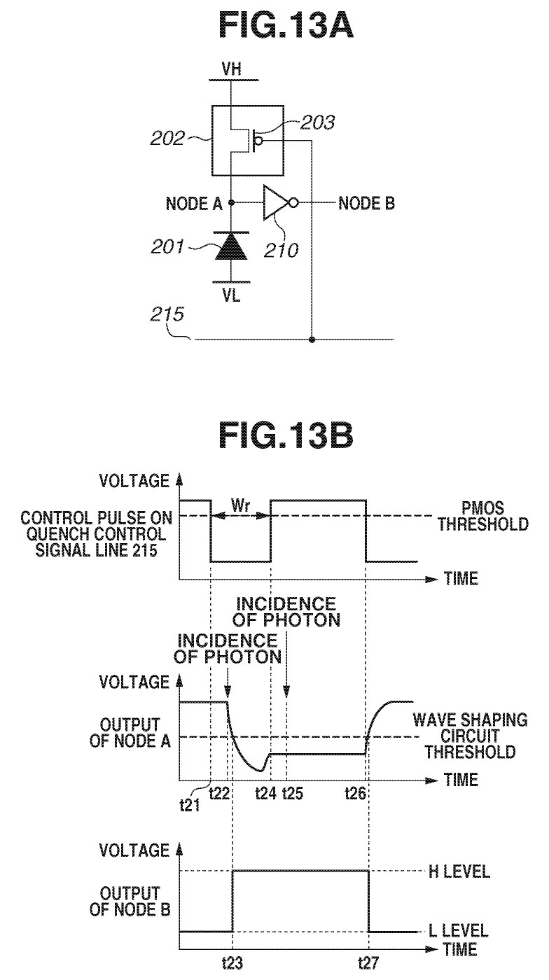

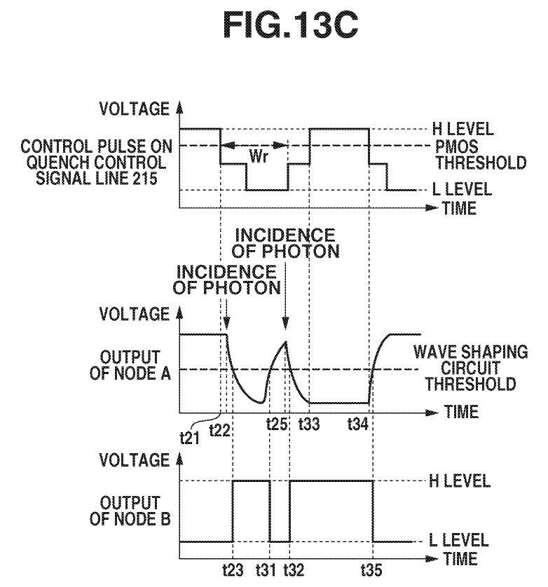

With reference to FIGS. 13A to 13C, a photoelectric conversion apparatus according to a fifth embodiment is described.

The photoelectric conversion apparatus according to the embodiment is different from that according to the first embodiment in that each of the control lines 116a and 116b is a control signal line connected to a transistor forming the quench element 202. The embodiment is substantially similar to the first embodiment except for this point and the points described below, and therefore, these points are not described.

FIG. 13A is a block diagram illustrating excerpts of a part of a single pixel 101 of the photoelectric conversion apparatus according to the embodiment. In the embodiment, a MOS transistor 203 is used as the quench element 202. Although FIG. 13A illustrates a positive-MOS (PMOS) transistor as an example, the MOS transistor 203 may be a negative-MOS (NMOS) transistor. A recharge operation of the MOS transistor 203 is controlled by a control pulse supplied from a control signal line 215.

With reference to FIGS. 13B and 13C, circuit operations according to a comparative embodiment and the embodiment are described.

FIG. 13B is a diagram illustrating the circuit operation according to the embodiment and illustrates an example of a control pulse on the control signal line 215 in the pixel 101F illustrated in FIG. 5B. During a period Wr from a time t21 to a time t24 and the period at and after a time t26, the voltage of the control pulse falls below a threshold voltage of the MOS transistor 203. Thus, in one embodiment, only during these periods, the MOS transistor 203 is in an on state, the node A is recharged, and the voltage rises. At this time, the pulse width of the control pulse on the control signal line 215 is the period when the control pulse falls below the threshold voltage of the MOS transistor 203. Such an operation has the effect of limiting a timing when the recharge operation is performed and preventing the situation where avalanche multiplication does not stop in a case where many photons are incident, thereby reducing power consumption.

At the time t21, the voltage value of the control pulse falls below the threshold voltage of the MOS transistor 203. Then, at a time t22, if a photon is incident on the APD 201, an avalanche multiplication current flows through the MOS transistor 203, and the voltage of the node A drops due to this current and the on-resistance of the MOS transistor 203. If the amount of the voltage drop becomes greater and the potential difference applied to the APD 201 becomes smaller, the avalanche multiplication in the APD 201 stops, and the voltage level of the node A does not drop any further beyond a certain value. Then, a current that compensates for the voltage drop flows through the node A from the voltage VH, and the voltage of the node A rises. However, at the time t24, the MOS transistor 203 enters an off state, and the current stops. Thus, the voltage rise in the node A stops. In this state, reverse bias voltages applied to the APD 201 are insufficient for the APD 201 to operate in the Geiger mode and perform the avalanche multiplication operation according to the incidence of a photon. Then, at a time t25, even if a photon is incident on the APD 201, avalanche multiplication does not occur. Then, at the time t26, the MOS transistor 203 enters the on state again, and the voltage of the node A rises. Regarding the node B, at a time t23, the voltage of the node A falls below a threshold for the waveform shaping unit 210, whereby the node B shifts from the L level to the H level. At a time t27, the voltage of the node A exceeds the determination threshold, whereby the node B shifts from the H level to the L level.

Next, with reference to FIG. 13C, the circuit operation of the pixel 101C according to the comparative embodiment is described. FIG. 13C illustrates an example of a control pulse on the control signal line 215 in the pixel 101C illustrated in FIG. 5A. Portions similar to those in FIG. 13B are not described.

Although the H level and the L level of the pulse are switched from those in FIG. 6A, also in the embodiment, the pulse width changes similarly to FIG. 6A. During a period Wr from a time t21 to a time t33 and the period at and after a time t34, the voltage value of the control pulse falls below the threshold voltage of the MOS transistor 203. Thus, in one embodiment, only during these periods, the MOS transistor 203 is in an on state, the voltage of the node A is recharged, and the voltage rises. At this time, the period from the time t21 to the time t33 is longer than the period Wr in FIG. 13B.

At the time t21, the voltage value of the control pulse falls below the threshold voltage of the MOS transistor 203.

Then, at a time t22, if a photon is incident on the APD 201, an avalanche multiplication current flows through the MOS transistor 203, and the voltage of the node A drops due to this current and the on-resistance of the MOS transistor 203. If the amount of the voltage drop becomes greater and the potential difference applied to the APD 201 becomes smaller, the avalanche multiplication in the APD 201 stops, and the voltage level of the node A does not drop any further beyond a certain value. Then, a current that compensates for the voltage drop flows through the node A from the voltage VH, and the voltage of the node A rises.

In the comparative embodiment, since the period when the MOS transistor 203 is in the on state is longer than the period Wr, the voltage rise in the node A does not stop. Then, reverse bias voltages applied to the APD 201 return to voltages sufficient for the APD 201 to operate in the Geiger mode and perform the avalanche multiplication operation according to the incidence of a photon. Thus, at a time t25, if a photon is incident again, an avalanche multiplication current flows through the MOS transistor 203 again, and the voltage of the node A drops due to this current and the on-resistance of the MOS transistor 203. If the amount of the voltage drop becomes greater and the potential difference applied to the APD 201 becomes smaller, the avalanche multiplication in the APD 201 stops, and the voltage level of the node A does not drop any further beyond a certain value. Then, at a time t34, the MOS transistor 203 enters the on state again, and the voltage of the node A rises.

Regarding the node B, at a time t23, the voltage of the node A falls below the determination threshold, whereby the node B shifts from the L level to the H level. At a time t31, the voltage of the node A exceeds the determination threshold, whereby the node B shifts from the H level to the L level. At a time t32, the voltage of the node A falls below the determination threshold, whereby the node B shifts from the L level to the H level. At a time t35, the voltage of the node A exceeds the determination threshold, whereby the node B shifts from the H level to the L level.

According to the comparative embodiment, the circuit is driven in response to two photons, and consumption current increases by an amount corresponding to this. On the other hand, according to the embodiment, if at least one photon is incident on the APD 201 during a certain period, then from this point onward, it is possible to reduce consumption current without causing avalanche multiplication.

According to the embodiment, it is possible to achieve a photoelectric conversion apparatus that reduces power consumption.

In the embodiment, the configurations described in the second to fourth embodiments may be appropriately combined.

### Sixth Embodiment

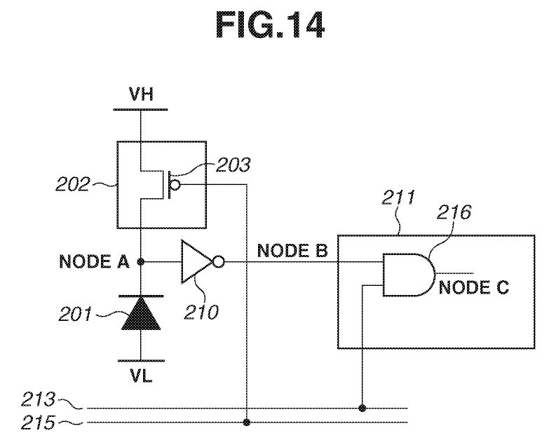

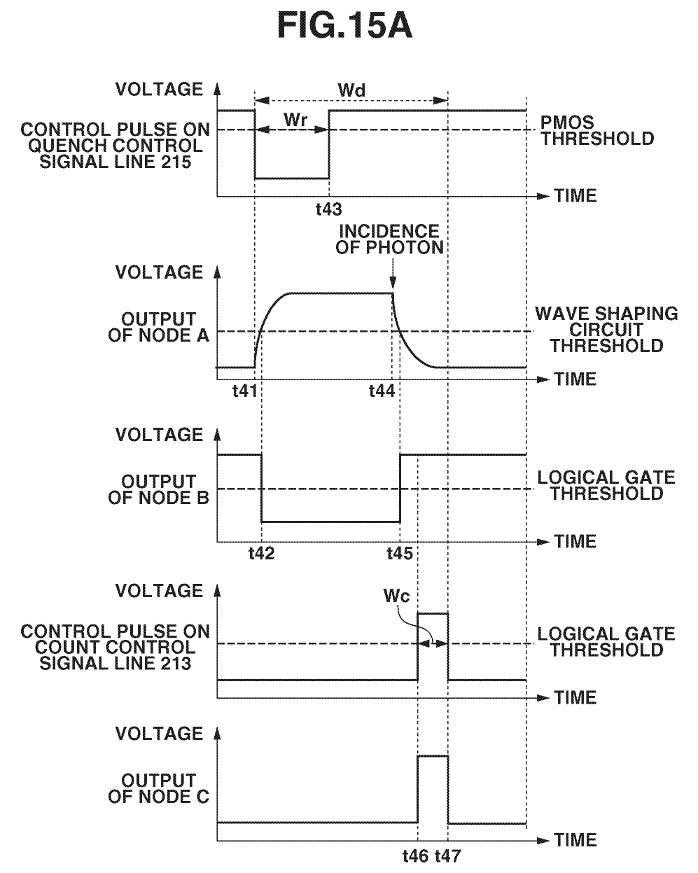

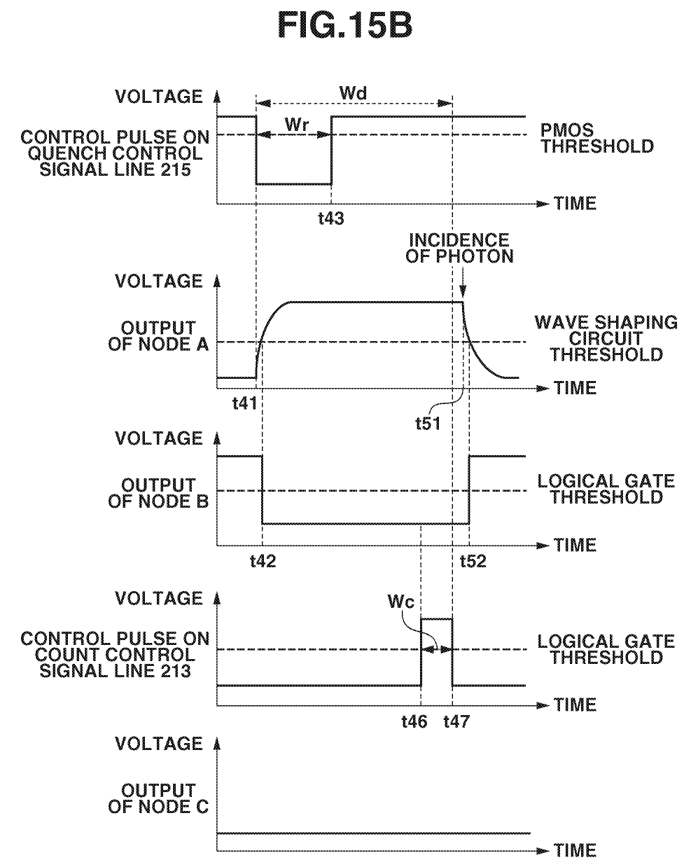

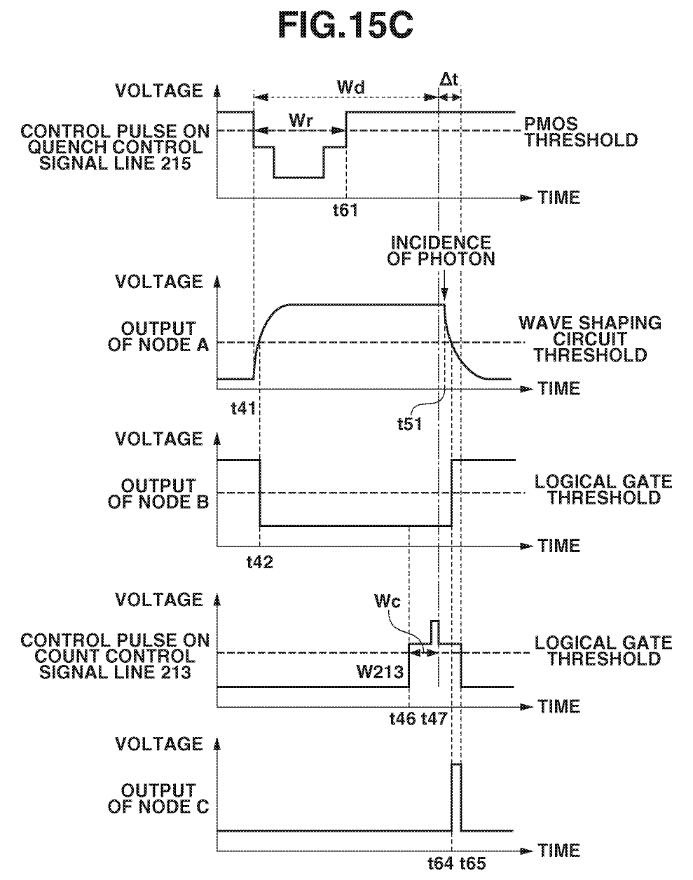

With reference to FIGS. 14 and 15A to 15C, a photoelectric conversion apparatus according to a sixth embodiment is described.

The photoelectric conversion apparatus according to the embodiment is different from that according to the fifth embodiment in that the photoelectric conversion apparatus according to the embodiment further includes a control signal line 213 connected to the counter circuit 211 in the pixel 101 according to the fifth embodiment. The embodiment is substantially similar to the fifth embodiment except for this point and the points described below, and therefore, these points are not described.

FIG. 14 is a block diagram illustrating excerpts of a part of a single pixel 101 according to the embodiment. In the embodiment, the node B that is the output of the waveform shaping unit 210 is connected to one of the input terminals of an AND gate circuit 216 placed in the counter circuit 211, a control signal line 213 is connected to the other input terminal, and a control pulse is supplied to the other input terminal. Although not illustrated, for example, a node C that is the output of the AND gate circuit 216 is connected to a logic circuit having the function of a memory such as a latch circuit at a subsequent stage or the like.

With reference to FIGS. 15A and 15B, a circuit operation in FIG. 14 according to the embodiment is described. FIG. 15A illustrates examples of control pulses on the control signal line 213 that controls the counter circuit 211 and the control signal line 215 in the pixel 101F according to the embodiment. FIG. 15B illustrates other examples.

First, the examples of the control pulses in FIG. 15A are described.

During a period Wr from a time t41 to a time t43, the voltage value of the control pulse falls below the threshold voltage of the MOS transistor 203. Thus, in one embodiment, only during this period, the MOS transistor is in an on state, the voltage of the node A is recharged, and the voltage rises.

At the time t41, the recharge is started, and the potential of the node A rises. At a time t42, the voltage of the node A exceeds the threshold for the waveform shaping unit 210, whereby the output of the node B switches to the L level. Then, the recharge operation is completed, and the potential of the node A becomes constant. Then, at the time t43, the control pulse on the control signal line 215 exceeds the threshold for the MOS transistor 203, and the MOS transistor 203 enters an off state where the MOS transistor 203 does not pass a current. Thus, from this point onward, the recharge operation is not performed. At a time t44, if a photon is incident on the APD 201, an avalanche multiplication current flows through the MOS transistor 203, and the voltage of the node A drops due to this current and the on-resistance of the MOS transistor 203. At a time t45, the voltage of the node A falls below the threshold for the waveform shaping unit 210, whereby the output of the node B switches to the H level. Then, if the amount of the voltage drop becomes greater and the potential difference applied to the APD 201 becomes smaller, the avalanche multiplication in the APD 201 stops, and the voltage level of the node A does not drop any further beyond a certain value. As described above, since the recharge operation is not performed, from this point onward, the voltage level of the node A remains constant after dropping. At a time t46, the voltage of the node B and the control pulse on the control signal line 213 that are the input of the AND gate circuit 216 both exceed a logic gate threshold, and therefore, the H level is output to the node C that is the output of the AND gate circuit 216. Then, at a time t47, the control signal on the control signal line 213 falls below the logic gate threshold. Thus, the node C shifts to the L level.

FIG. 15B illustrates other examples of the control pulses on the control signal line 213 and the control signal line 215 in the pixel 101F according to the embodiment in FIG. 5B. During a period Wr from a time t41 to a time t43, the voltage of the node A is recharged. Portions similar to FIG. 15A are not described.

At the time t41, the recharge is started, the potential of the node A rises, and the potential of the node A becomes constant. Then, at and after the time t43, the recharge operation is not performed. At a time t51, if a photon is incident on the APD 201, the voltage of the node A drops. At a time t52, the voltage of the node A falls below the threshold for the waveform shaping unit 210, whereby the output of the node B switches to the H level. Then, the voltage level of the node A has a constant value. Unlike FIG. 15A, the time t51 that is the incidence timing of a photon is after a time t47 when the control pulse on the control signal line 213 falls. Thus, there is no timing when both the voltage of the node B and the control signal on the control signal line 213 simultaneously exceed the logic gate threshold, and therefore, the node C remains at the L level. Then, if a photon is incident on the APD 201 during a period Wd from the time t41 when the control pulse on the control signal line 215 switches from the H level to the L level to the time t47 when the control pulse on the control signal line 213 switches from the H level to the L level, a pulse is output to the node C.

FIG. 15C illustrates an example of a control pulse on the control signal line 215 in the pixel 101C according to the comparative embodiment in FIG. 5A. Portions similar to those in FIGS. 15A and 15B are not described.

During a period Wr from a time t41 to a time t61, the voltage of the node A is recharged. At the time t41, the recharge is started, the potential of the node A rises, and the potential of the node A becomes constant. Then, at and after the time t61, the recharge operation is not performed.

At this time, the period Wr from the time t41 to the time t61, i.e., the period when the control pulse on the control signal line 215 falls below the threshold voltage of the MOS transistor 203, is longer than the normal pulse width Wr, similarly to FIG. 15B.

At the time t41, the recharge is started, the potential of the node A rises, and the potential of the node A becomes constant. Then, at and after the time t61, the recharge operation is not performed. At the time t51, if a photon is incident on the APD 201, the voltage of the node A drops. At a time t64, the voltage of the node A falls below the threshold for the waveform shaping unit 210, whereby the output of the node B switches to the H level. Then, the voltage level of the node A has a constant value.

Similarly to the state where the width of the control pulse on the control signal line 215 is extended, the control pulse on the control signal line 213 is also extended beyond a pulse width in FIGS. 13B and 13C. At this time, the pulse width of the control pulse on the control signal line 213 is defined as a period when the control pulse exceeds the logic gate threshold voltage. Consequently, at a time t47 after the lapse of a period Wd from the time t41, even though the control pulse on the control signal line 213 is to fall below the logic gate threshold for the AND gate circuit 216, the control pulse on the control signal line 213 does not fall below the logic gate threshold for the AND gate circuit 216 until a time t65 because the pulse is longer. Thus, the photon incident at the time t51 after the lapse of the period Wd switches the node C to the H level. That is, although, normally, a pulse is to be output to the node C in a case where a photon is incident on the APD 201 during the period Wd, a pulse is output to the node C in a case where a photon is incident on the APD 201 during a period Wd+Δt. Consequently, for example, in the use of TOF for measuring a distance based on the flight time of a photon, a distance measurement error occurs.

According to the embodiment, it is possible to make a shift in the timing of the detection of a photon less likely to occur than in the comparative embodiment. Thus, it is possible to improve the detection accuracy of a photon.

### Seventh Embodiment

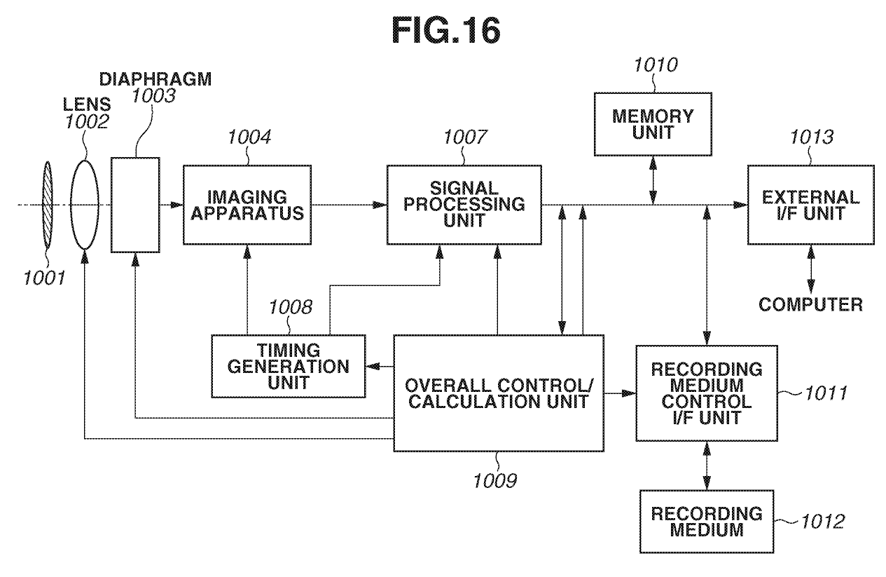

With reference to FIG. 16, a photoelectric conversion system according to a seventh embodiment is described. FIG. 16 is a block diagram illustrating the general configuration of the photoelectric conversion system according to the embodiment.

The photoelectric conversion apparatus described in each of the above embodiments is applicable to various photoelectric conversion systems. Examples of the various photoelectric conversion systems include a digital still camera, a digital camcorder, a monitoring camera, a copying machine, a fax, a mobile phone, an in-vehicle camera, an observation satellite, and the like.

The various photoelectric conversion systems also include a camera module including an optical system such as a lens or the like and an imaging apparatus. FIG. 16 illustrates a block diagram of a digital still camera as one of these examples.

The photoelectric conversion system illustrated in FIG. 16 includes an imaging apparatus 1004 as an example of the photoelectric conversion apparatus, and a lens 1002 that forms an optical image of an object on the imaging apparatus 1004. Further, the photoelectric conversion system includes a diaphragm 1003 that makes the amount of light passing through the lens 1002 variable, and a barrier 1001 that protects the lens 1002. The lens 1002 and the diaphragm 1003 are an optical system for collecting light on the imaging apparatus 1004. The imaging apparatus 1004 is the photoelectric conversion apparatus according to any of the above embodiments and converts the optical image formed by the lens 1002 into an electric signal.

The photoelectric conversion system includes a signal processing unit 1007 that is an image generation unit that processes an output signal output from the imaging apparatus 1004, thereby generating an image. The signal processing unit 1007 performs an operation of performing various types of correction and compression where necessary and outputting image data. The signal processing unit 1007 may be formed on a semiconductor layer on which the imaging apparatus 1004 is provided, or may be formed on a semiconductor layer different from that of the imaging apparatus 1004. The imaging apparatus 1004 and the signal processing unit 1007 may be formed on the same semiconductor layer.

The photoelectric conversion system further includes a memory unit 1010 that temporarily stores image data, and an external interface unit (external I/F unit) 1013 for communicating with an external computer or the like. Further, the photoelectric conversion system includes a recording medium 1012 such as a semiconductor memory or the like in or from which captured data is recorded or read, and a recording medium control interface unit (recording medium control I/F unit) 1011 for recording or reading image data in or from the recording medium 1012. The recording medium 1012 may be built into the photoelectric conversion system, or may be attachable to and detachable from the photoelectric conversion system.

Further, the photoelectric conversion system includes an overall control/calculation unit 1009 that performs various calculations and controls the entirety of the digital still camera, and a timing generation unit 1008 that outputs various timing signals to the imaging apparatus 1004 and the signal processing unit 1007. The timing signals or the like may be input from outside, and the photoelectric conversion system may only need to include at least the imaging apparatus 1004 and the signal processing unit 1007 that processes an output signal output from the imaging apparatus 1004.

The imaging apparatus 1004 outputs an imaging signal to the signal processing unit 1007. The signal processing unit 1007 performs predetermined signal processing on the imaging signal output from the imaging apparatus 1004 and outputs image data. The signal processing unit 1007 generates an image using the imaging signal.

As described above, according to the embodiment, it is possible to achieve a photoelectric conversion system to which the photoelectric conversion apparatus (an imaging apparatus) according to any of the above embodiments is applied.

### Eighth Embodiment

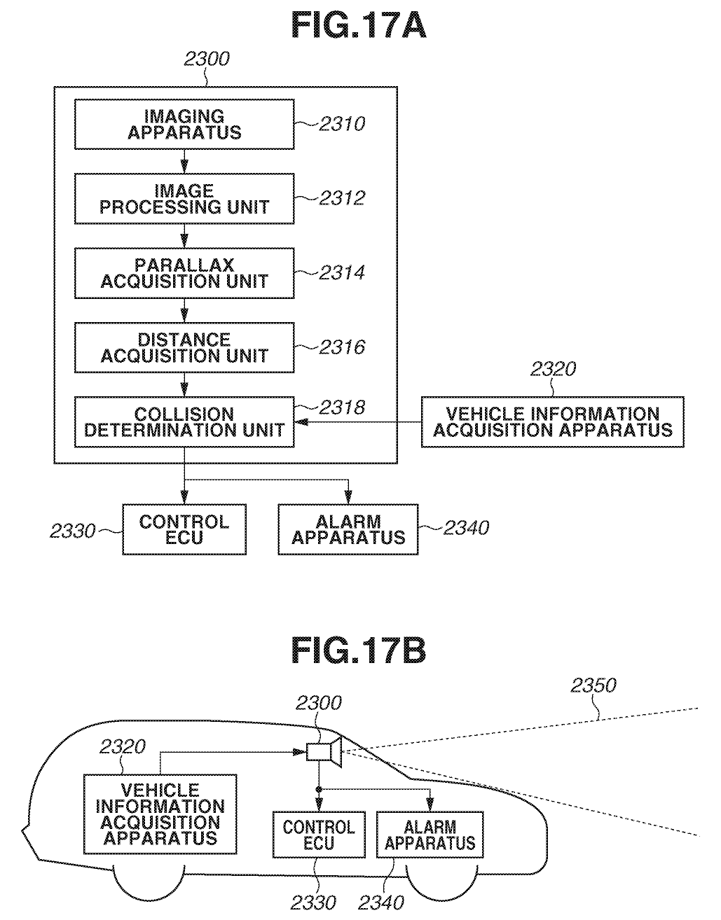

With reference to FIGS. 17A and 17B, a photoelectric conversion system and a movable body according to an eighth embodiment are described. FIGS. 17A and 17B are diagrams illustrating the configurations of the photoelectric conversion system and the movable body according to the embodiment.

FIG. 17A illustrates an example of a photoelectric conversion system regarding an in-vehicle camera. A photoelectric conversion system 2300 includes an imaging apparatus 2310. The imaging apparatus 2310 is the photoelectric conversion apparatus according to any of the above embodiments. The photoelectric conversion system 2300 includes an image processing unit 2312 that performs image processing on a plurality of pieces of image data acquired by the imaging apparatus 2310. The photoelectric conversion system 2300 also includes a parallax acquisition unit 2314 that calculates a parallax (the phase difference between parallax images) from the plurality of pieces of image data acquired by the photoelectric conversion system 2300. Further, the photoelectric conversion system 2300 includes a distance acquisition unit 2316 that calculates the distance to a target object based on the calculated parallax, and a collision determination unit 2318 that, based on the calculated distance, determines whether there is a possibility of a collision. The parallax acquisition unit 2314 and the distance acquisition unit 2316 are examples of a distance information acquisition unit that acquires distance information regarding the distance to a target object. That is, the distance information may be acquired using not only the phase difference but also a TOF technique. The collision determination unit 2318 may determine the possibility of a collision using any of these pieces of distance information. The distance information acquisition unit may be achieved by exclusively designed hardware, or may be achieved by a software module. Alternatively, the distance information acquisition unit may be achieved by a field-programmable gate array (FPGA), an application-specific integrated circuit (ASIC), or the like, or may be achieved by the combination of these.

The photoelectric conversion system 2300 is connected to a vehicle information acquisition apparatus 2320 and can acquire vehicle information such as the speed of a vehicle, the yaw rate, the steering angle, and the like. The photoelectric conversion system 2300 is also connected to a control electronic control unit (ECU) 2330 that is a control apparatus (a control unit) that outputs a control signal for producing a braking force in the vehicle based on the determination result of the collision determination unit 2318. The photoelectric conversion system 2300 is also connected to an alarm apparatus 2340 that gives an alarm to a driver based on the determination result of the collision determination unit 2318. For example, if there is a high possibility of a collision as the determination result of the collision determination unit 2318, for example, the control ECU 2330 applies a brake, returns the gas pedal, or suppresses the engine output, thereby controlling the vehicle to avoid a collision and reduce damage.

The alarm apparatus 2340 warns a user by, for example, setting off an alarm such as a sound or the like, displaying alarm information on a screen of an automotive navigation system or the like, or imparting a vibration to a seat belt or the steering.

In the embodiment, the photoelectric conversion system 2300 captures the periphery, such as the front direction or the rear direction, of the vehicle. FIG. 17B illustrates the photoelectric conversion system 2300 in a case where the photoelectric conversion system 2300 captures the front direction of the vehicle (an imaging range 2350). The vehicle information acquisition apparatus 2320 sends an instruction to the photoelectric conversion system 2300 or the imaging apparatus 2310. With this configuration, it is possible to further improve the accuracy of distance measurement.

In the above description, an example has been described where a vehicle is controlled to avoid colliding with another vehicle. Alternatively, the embodiment is also applicable to control for automatically driving a vehicle by following another vehicle, control for automatically driving a vehicle so as to stay in a lane, or the like. Further, the photoelectric conversion system can be applied not only to a vehicle such as an automobile or the like but also to a movable body (a moving apparatus) such as a vessel, an aircraft, an industrial robot, or the like. Additionally, the photoelectric conversion system can be applied not only to a movable body but also to a device widely using object recognition, such as an intelligent transportation system (ITS) or the like.

### Ninth Embodiment

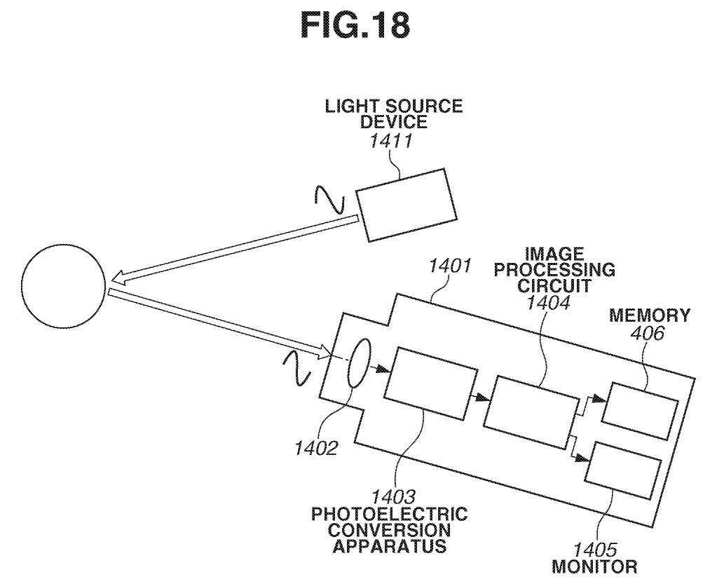

With reference to FIG. 18, a photoelectric conversion system according to a ninth embodiment is described. FIG. 18 is a block diagram illustrating an example of the configuration of a distance image sensor that is the photoelectric conversion system.

As illustrated in FIG. 18, a distance image sensor 1401 includes an optical system 1402, a photoelectric conversion apparatus 1403, an image processing circuit 1404, a monitor 1405, and a memory 1406. Then, the distance image sensor 1401 receives light (modulated light or pulsed light) projected from a light source device 1411 toward an object and reflected from the surface of the object and thereby can acquire a distance image according to the distance to the object.

The optical system 1402 includes one or more lenses. The optical system 1402 guides image light (incident light) from the object to the photoelectric conversion apparatus 1403 and forms an image on a light-receiving surface (a sensor unit) of the photoelectric conversion apparatus 1403.

As the photoelectric conversion apparatus 1403, the photoelectric conversion apparatus according to any of the above embodiments is applied, and a distance signal indicating the distance obtained from a received light signal output from the photoelectric conversion apparatus 1403 is supplied to the image processing circuit 1404.

The image processing circuit 1404 performs image processing for constructing a distance image based on the distance signal supplied from the photoelectric conversion apparatus 1403. Then, the distance image (image data) obtained by the image processing is supplied to and displayed on the monitor 1405 or is supplied to and stored (recorded) in the memory 1406.

In the thus configured distance image sensor 1401, any of the above photoelectric conversion apparatuses is applied, whereby, for example, it is possible to acquire a more accurate distance image according to an improvement in the characteristics of pixels.

### Tenth Embodiment

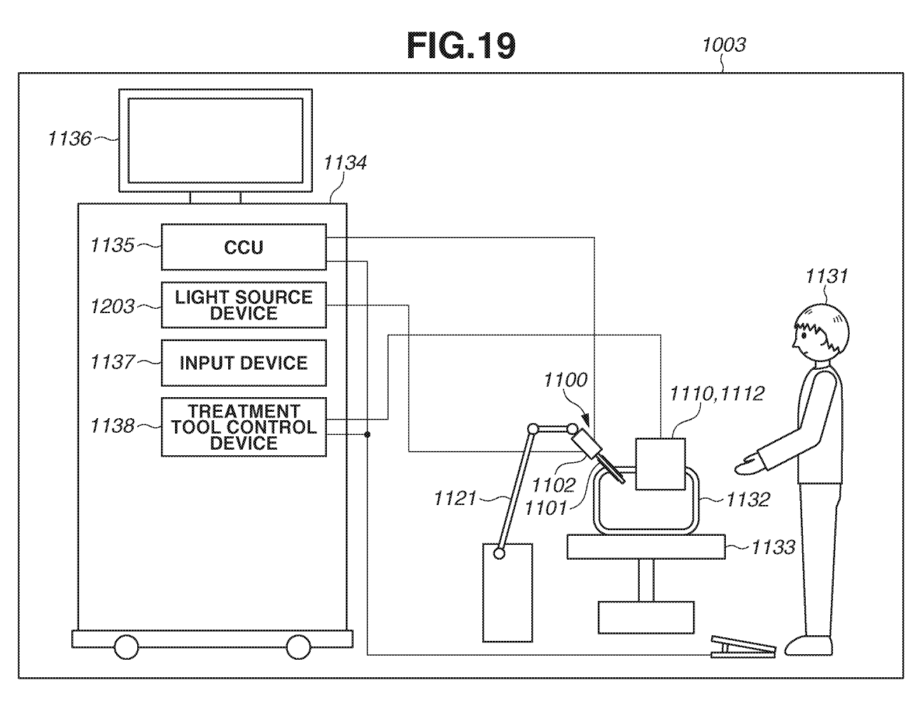

With reference to FIG. 19, a photoelectric conversion system according to a tenth embodiment is described. FIG. 19 is a diagram illustrating an example of the general configuration of an endoscopic surgical system that is the photoelectric conversion system according to the embodiment.

FIG. 19 illustrates the state where an operator (doctor) 1131 performs surgery on a patient 1132 on a patient bed 1133 using an endoscopic surgical system 1103. As illustrated in FIG. 19, the endoscopic surgical system 1103 includes an endoscope 1100, surgical tools 1110, and a cart 1134 on which various devices for endoscopic surgery are mounted.

The endoscope 1100 includes a lens barrel 1101 in which a region having a predetermined length from the front end of the lens barrel 1101 is inserted into a cavity of the body of the patient 1132, and a camera head 1102 connected to the base end of the lens barrel 1101. Although this example illustrates the endoscope 1100 configured as a so-called rigid scope including the rigid lens barrel 1101, the endoscope 1100 may be configured as a so-called flexible scope including a flexible lens barrel.

At the front end of the lens barrel 1101, an opening portion to which an objective lens is fitted is provided. A light source device 1203 is connected to the endoscope 1100. Light generated by the light source device 1203 is guided to the front end of the lens barrel 1101 by a light guide extending inside the lens barrel 1101, passes through the objective lens, and is emitted toward an observation target in the cavity of the body of the patient 1132. The endoscope 1100 may be a forward-viewing endoscope, or may be an oblique-viewing endoscope or a side-viewing endoscope.

Inside the camera head 1102, an optical system and a photoelectric conversion apparatus are provided, and reflected light (observation light) from the observation target is collected on the photoelectric conversion apparatus by the optical system. The observation light is photoelectrically converted by the photoelectric conversion apparatus, and an electric signal corresponding to the observation light, i.e., an image signal corresponding to an observation image, is generated. As the photoelectric conversion apparatus, the photoelectric conversion apparatus according to any of the above embodiments can be used. The image signal is transmitted as raw data to a camera control unit (CCU) 1135.

The CCU 1135 includes a central processing unit (CPU), a graphics processing unit (GPU), and the like and performs overall control of the operations of the endoscope 1100 and a display device 1136. Further, the CCU 1135 receives the image signal from the camera head 1102 and performs various types of image processing for displaying an image based on the image signal, such as a development process (a demosaic process) and the like, on the image signal.

Under control of the CCU 1135, the display device 1136 displays the image based on the image signal subjected to the image processing by the CCU 1135.

The light source device 1203 includes a light source such as a light-emitting diode (LED) or the like and supplies emission light for capturing a surgical site or the like to the endoscope 1100.

An input device 1137 is an input interface for providing an input to the endoscopic surgical system 1103. The user can input various pieces of information and input an instruction to the endoscopic surgical system 1103 through the input device 1137.

A treatment tool control device 1138 controls the driving of energy treatment tools 1112 for, for example, cauterizing or incising tissue or sealing blood vessels.

The light source device 1203 that supplies emission light for capturing a surgical site to the endoscope 1100 can be composed of, for example, an LED, a laser light source, or a white light source configured by the combination of these. In a case where a white light source is configured by the combination of red, green, and blue (RGB) laser light sources, the output intensity and the output timing of each color (each wavelength) can be controlled with high accuracy. Thus, the light source device 1203 can adjust the white balance of a captured image. In this case, laser light from each of the RGB laser light sources is emitted to the observation target in a time division manner, and the driving of an imaging element of the camera head 1102 is controlled in synchronization with the emission timing of the laser light, whereby it is also possible to capture an image corresponding to each of RGB in a time division manner. Based on this method, it is possible to obtain a color image without providing color filters in the imaging element.

The driving of the light source device 1203 may be controlled to change the intensity of light output from the light source device 1203 every predetermined time. In synchronization with the timing of the change in the intensity of the light, the driving of the imaging element of the camera head 1102 is controlled to acquire images in a time division manner, and the images are combined together, whereby it is possible to generate a high dynamic range image without so-called blocked-up shadows and blown-out highlights.

The light source device 1203 may also be configured to supply light in a predetermined wavelength band corresponding to special light observation. In the special light observation, for example, the wavelength dependence of the absorption of light in the tissue of the body is used. Specifically, by emitting light having a narrower bandwidth compared to the emission light (i.e., white light) used during normal observation, predetermined tissues such as blood vessels in the mucosal surface layer are imaged with high contrast.

Alternatively, in the special light observation, fluorescence observation for obtaining an image with fluorescent light generated by emitting excitation light may be performed. In the fluorescence observation, excitation light can be emitted to the tissue of the body, and fluorescent light from the tissue of the body can be observed. Or, for example, a reagent such as indocyanine green (ICG) or the like can be locally injected into the tissue of the body, excitation light corresponding to the fluorescence wavelength of the reagent can be emitted to the tissue of the body, and a fluorescent image can be obtained. The light source device 1203 can be configured to supply narrow-band light and/or excitation light corresponding to such special light observation.

### Eleventh Embodiment

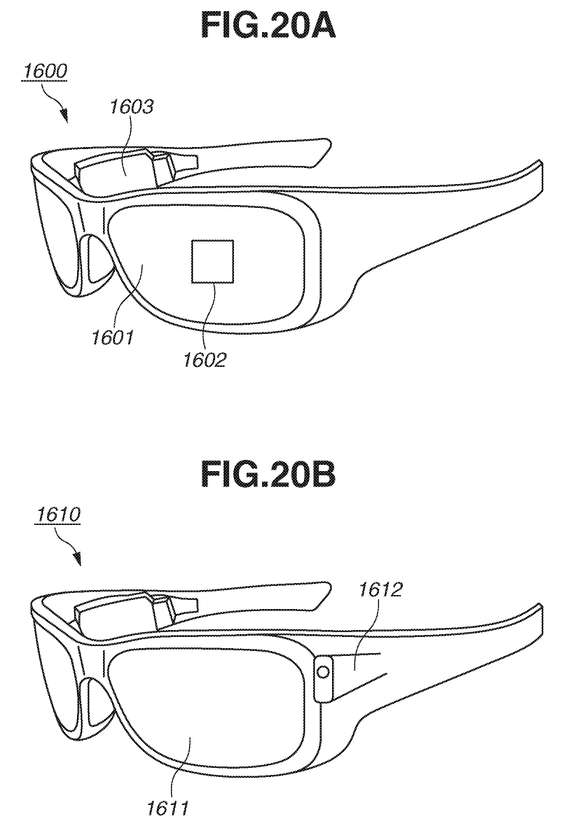

With reference to FIGS. 20A and 20B, a photoelectric conversion system according to an eleventh embodiment is described. FIG. 20A is a diagram illustrating an example of the configuration of eyeglasses 1600 (smart glasses) that are the photoelectric conversion system.

The eyeglasses 1600 include a photoelectric conversion apparatus 1602. The photoelectric conversion apparatus 1602 is the photoelectric conversion apparatus according to any of the above embodiments. On the back surface side of a lens 1601, a display device including a light-emitting device such as an organic light-emitting diode (OLED), an LED, or the like may be provided. A single photoelectric conversion apparatus 1602 may be provided, or a plurality of photoelectric conversion apparatuses 1602 may be provided. Alternatively, a plurality of types of photoelectric conversion apparatuses may be used in combination. The placement position of the photoelectric conversion apparatus 1602 is not limited to that in FIG. 20A.

The eyeglasses 1600 further include a control apparatus 1603. The control apparatus 1603 functions as a power supply that supplies power to the photoelectric conversion apparatus 1602 and the display device. The control apparatus 1603 also controls the operations of the photoelectric conversion apparatus 1602 and the display device. In the lens 1601, an optical system for collecting light on the photoelectric conversion apparatus 1602 is formed.

FIG. 20B illustrates eyeglasses 1610 (smart glasses) according to an application example. The eyeglasses 1610 include a control apparatus 1612. On the control apparatus 1612, a photoelectric conversion apparatus equivalent to the photoelectric conversion apparatus 1602 and a display device are mounted. In a lens 1611, an optical system for projecting light emitted from the photoelectric conversion apparatus and the display device in the control apparatus 1612 is formed. An image is projected onto the lens 1611. The control apparatus 1612 functions as a power supply that supplies power to the photoelectric conversion apparatus and the display device, and also controls the operations of the photoelectric conversion apparatus and the display device. The control apparatus 1612 may include a line-of-sight detection unit that detects the line of sight of a wearer (a user). The line of sight may be detected using infrared light. An infrared light-emitting unit emits infrared light to the eyeball of the user gazing at a display image. An imaging unit including a light-receiving element detects reflected light of the emitted infrared light from the eyeball, thereby obtaining a captured image of the eyeball. The control apparatus 1612 includes a reduction unit that reduces light from the infrared light-emitting unit to a display unit in a planar view, thereby reducing a decrease in the grade of the image.

The line of sight of the user to the display image is detected from the captured image of the eyeball obtained by capturing the infrared light. Any known technique can be applied to the line-of-sight detection using the captured image of the eyeball. As an example, a line-of-sight detection method based on a Purkinje image formed by the reflection of emitted light in the cornea can be used.

More specifically, a line-of-sight detection process based on a pupil-corneal reflection method is performed. Using the pupil-corneal reflection method, a line-of-sight vector indicating the direction (the rotation angle) of the eyeball is calculated based on an image of the pupil and a Purkinje image included in the captured image of the eyeball, thereby detecting the line of sight of the user.

The display device according to the embodiment may include a photoelectric conversion apparatus including a light-receiving element and control a display image on the display device based on line-of-sight information regarding a user from the photoelectric conversion apparatus.

Specifically, based on the line-of-sight information, the display device determines a first field-of-view region gazed at by the user and a second field-of-view region other than the first field-of-view region. The first and second field-of-view regions may be determined by a control apparatus of the display device, or the display device may receive the first and second field-of-view regions determined by an external control apparatus. In a display region of the display device, the display resolution of the first field-of-view region may be controlled to be higher than the display resolution of the second field-of-view region. That is, the resolution of the second field-of-view region may be set to be lower than that of the first field-of-view region.

The display region may include a first display region and a second display region different from the first display region, and based on the line-of-sight information, a region having high priority may be determined between the first and second display regions. The first and second display regions may be determined by the control apparatus of the display device, or the display device may receive the first and second display regions determined by the external control apparatus. The resolution of the region having high priority may be controlled to be higher than the resolution of a region other than the region having high priority. That is, the resolution of a region having relatively low priority may be set to be low.

The first field-of-view region and the region having high priority may be determined using artificial intelligence (AI). The AI may be a model configured to, using as supervised data an image of an eyeball and a direction actually viewed by the eyeball in the image, estimate the angle of the line of sight and the distance to an object in the line of sight based on an image of an eyeball. An AI program may be included in the display device, or may be included in the photoelectric conversion apparatus, or may be included in an external apparatus. In a case where the AI program is included in the external apparatus, the AI program is transmitted from the external apparatus to the display device through communication.

In a case where display control is performed based on line-of-sight detection, the display device can be suitably applied to smart glasses further including a photoelectric conversion apparatus that captures the outside. The smart glasses can display information regarding the captured outside in real time.

The embodiments described above may be appropriately modified within a scope that does not depart from the technical concept. Examples in which part of the configuration of one embodiment is added to another embodiment, or in which part of the configuration of one embodiment is replaced with that of another embodiment, are also included in the embodiments of the disclosure.

Each of the above embodiments merely illustrates examples of concretization for implementing the disclosure, and the technical scope of the disclosure should not be construed as being limited thereto.

That is, the disclosure can be implemented in various forms without departing from its technical concept or its essential features.

According to the disclosure, it is possible to provide a photoelectric conversion apparatus capable of achieving at least one of a reduction in power consumption, an improvement in the detection accuracy of a photon, and the stabilization of the reading time of data.

While the disclosure has been described with reference to embodiments, it is to be understood that the disclosure is not limited to the disclosed embodiments. The scope of the following claims is to be accorded the broadest interpretation so as to encompass all such modifications and equivalent structures and functions.

This application claims the benefit of Japanese Patent Application No. 2025-046431, filed Mar. 21, 2025, which is hereby incorporated by reference herein in its entirety.

What is claimed is:

1. An apparatus comprising:
a plurality of pixels each including an avalanche photodiode and a transistor;
a first control circuit and a second control circuit;
a first control line connected to the first control circuit and a first pixel group including a plurality of pixels disposed next to each other in a first direction among the plurality of pixels; and
a second control line connected to the second control circuit and a second pixel group including a plurality of pixels disposed next to each other in the first direction among the plurality of pixels,
wherein the first control circuit is disposed in a first region, the second control circuit is disposed in a second region, and the first and second regions are formed using divided exposure,
wherein a first pixel in the first pixel group and a second pixel in the second pixel group are disposed adjacent to each other in the first direction,
wherein the first control line is connected to the first control circuit and the transistor included in the first pixel,
wherein the second control line is connected to the second control circuit and the transistor included in the second pixel and having a same function as a function of the transistor included in the first pixel, and
wherein the first and second control lines are electrically separated from each other.

2. The apparatus according to claim 1,
wherein the first pixel group is disposed in the first region, and the second pixel group is disposed in the second region, and
wherein a number of pixels disposed next to each other in the first direction in the first pixel group and a number of pixels disposed next to each other in the first direction in the second pixel group are same as each other.

3. The apparatus according to claim 1, wherein the first and second control lines each include a buffer circuit connected in series.

4. The apparatus according to claim 1,
wherein each of the plurality of pixels includes a quench element connected to one of nodes of the avalanche photodiode and a power supply,
wherein each of the transistor included in the first pixel and the transistor included in the second pixel is a transistor forming the quench element,
wherein the transistor included in the first pixel is disposed in the first region, and
wherein the transistor included in the second pixel is disposed in the second region.

5. The apparatus according to claim 1,
wherein each of the plurality of pixels includes a counter circuit configured to count a number of pulse signals based on a signal from the avalanche photodiode,
wherein each of the transistor included in the first pixel and the transistor included in the second pixel is a transistor configured to control the counter circuit,
wherein the transistor included in the first pixel is disposed in the first region, and
wherein the transistor included in the second pixel is disposed in the second region.

6. The apparatus according to claim 1, wherein wiring forming the first control line and wiring forming the second control line are manufactured using different photomasks.

7. The apparatus according to claim 1, wherein a timing at which the first control circuit outputs a control signal differs from a timing at which the second control circuit outputs a control signal.

8. The apparatus according to claim 1, wherein the first control line is connected to the first pixel group using a clock tree method.

9. A apparatus comprising:
a plurality of pixels each including an avalanche photodiode and a transistor,
wherein the apparatus is in a shape of a rectangle, and a length of one side of the rectangle is longer than 33 millimeters (mm), or lengths of the one side and another side of the rectangle are both longer than 26 mm,
the apparatus further comprising:
a first control circuit disposed in a first region;
a second control circuit disposed in a second region;
a first control line connected to the first control circuit and a first pixel group including a plurality of pixels disposed next to each other in a first direction among the plurality of pixels; and
a second control line connected to the second control circuit and a second pixel group including a plurality of pixels disposed next to each other in the first direction among the plurality of pixels,
wherein a first pixel in the first pixel group and a second pixel in the second pixel group are disposed adjacent to each other in the first direction,
wherein the first control line is connected to the first control circuit and the transistor included in the first pixel,
wherein the second control line is connected to the second control circuit and the transistor included in the second pixel and having a same function as a function of the transistor included in the first pixel, and
wherein the first and second control lines are separated from each other.

10. The apparatus according to claim 9, wherein a number of pixels disposed next to each other in the first direction in the first pixel group and a number of pixels disposed next to each other in the first direction in the second pixel group are same as each other.

11. The apparatus according to claim 9, wherein the first and second control lines each include a buffer circuit connected in series.

12. The apparatus according to claim 9,
wherein each of the plurality of pixels includes a quench element connected to one of nodes of the avalanche photodiode and a power supply,
wherein each of the transistor included in the first pixel and the transistor included in the second pixel is a transistor forming the quench element,
wherein the transistor included in the first pixel is disposed in the first region, and
wherein the transistor included in the second pixel is disposed in the second region.

13. The apparatus according to claim 9,
wherein each of the plurality of pixels includes a counter circuit configured to count a number of pulse signals based on a signal from the avalanche photodiode,
wherein each of the transistor included in the first pixel and the transistor included in the second pixel is a transistor configured to control the counter circuit,
wherein the transistor included in the first pixel is disposed in the first region, and
wherein the transistor included in the second pixel is disposed in the second region.

14. The apparatus according to claim 9, wherein wiring forming the first control line and wiring forming the second control line are manufactured using different photomasks.

15. The apparatus according to claim 9, wherein a timing at which the first control circuit outputs a control signal differs from a timing at which the second control circuit outputs a control signal.

16. The apparatus according to claim 9, wherein the first control line is connected to the first pixel group using a clock tree method.

17. The apparatus according to claim 1, further comprising:
a first substrate including the avalanche photodiode; and
a second substrate including the transistor,
wherein the second substrate and the first substrate are laminated together.

18. The apparatus according to claim 17, wherein the first substrate is formed using collective exposure.

19. A system comprising:
the apparatus according to claim 17; and
a signal processing unit configured to generate an image using a signal output from the apparatus.

20. A movable body comprising:
the apparatus according to claim 17; and
a control unit configured to control movement of the movable body using a signal output from the apparatus.
